(19) United States
(12) Patent Application Publication
(10) Pub. No.: US 2004/0209621 A1
(43) Pub. Date: Oct. 21, 2004

(54) Base station, a communication system, and a base station control apparatus

(75) Inventor: Keiichi Teshirogi, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: MITSUBISHI DENKI KABUSHIKI KAISHA, Tokyo (JP)

(21) Appl. No.: 10/682,117

(22) Filed: Oct. 10, 2003

(30) Foreign Application Priority Data
Apr. 18, 2003 (JP) 2003-113969

(51) Int. Cl. H04Q 7/20

(52) U.S. Cl. 455/450

(57) ABSTRACT

When all the channels-for-calling become in a state of being used (or when traffic exceeds a specific level) in a base station, the base station stops transmitting a control channel to a mobile station. Thereby, it becomes impossible for the mobile station in a waiting state at the base station to recognize the control channel of the base station. Then, the mobile station performs switching in order to receive a control channel of another base station having a vacant channel-for-calling in the vicinity. Thus, it is possible to reduce a call-loss rate in the whole system and time of call connection from the mobile station.

### BACKGROUND OF THE INVENTION

1. Field of the Invention

The present invention relates to a mobile communications system whose service area is composed of a plurality of cells, and especially to a communication control technology used by a base station, which is located in each cell, to control communication of a mobile station.

2. Description of the Related Art

In a mobile communications system, there is a place where a plurality of base stations are placed and a plurality of cells are partially overlapped so that communication of a mobile station may not stop or so that required traffic can be held in each place even if the mobile station moves.

In the conventional mobile communications system, when all channels-for-calling become in a state of being used in one base station, namely when no vacant channel-for-calling is available in the base station, there is no means of the base station's notifying a mobile station of no vacant channel-for-calling, before the mobile station which is in a waiting state at the base station transmits a call-connection-request to the base station.

For this reason, unless the mobile station receives a notification of refusal of the call-connection-request, because of there being no vacant channel, as a response to the call-connection-request from the mobile station, the mobile station in the state of waiting at the base station can not recognize there is no vacant channel in the base station.

FIG. 2 shows an operation example in the case of a call-connection-request in the conventional mobile communications system. Even when all channels-for-calling become in a state of being used and no channel is in a vacant state, a base station 1 does not notify a mobile station in a waiting state at the base station 1 of there being no vacant channel-for-calling. Then, when the mobile station which does not know that there is no vacant channel-for-calling in the base station 1 transmits a call-connection-request message, the base station 1 transmits a call-connection-request refusal message because of no vacant channel-for-calling. By receiving the call-connection-request refusal message, the mobile station in the state of waiting at the base station 1, for the first time, recognizes that there is no vacant channel-for-calling in the base station 1. Then, the mobile station receives a control channel of a base station 2 having a service area overlapped with that of the base station 1, and connects to the base station 2 to start communication.

As mentioned above, there is no means of notifying about no vacant channel, in the conventional mobile communications system. Therefore, unless a mobile station in a waiting state receives a notification of refusal of a call-connection-request, because of there being no vacant channel-for-calling, as a response to the call-connection-request from the mobile station, the mobile station can not recognize that there is no vacant channel-for-calling in the base station concerned.

Moreover, even when there is the notification of the call-connection-request refusal because of no vacant channel-for-calling from the base station, unless the mobile station autonomously switches the base station from which the mobile station received a control channel to other base station, the mobile station can not start communication, in the cell of the base station having no vacant channel-for-calling.

Even when the mobile station autonomously switches the base station from which the mobile station received a control channel to other base station, and receives a control channel from other base station, the mobile station needs to transmit a call-connection-request to a plurality of base stations respectively in the case of there being a plurality of base stations having no vacant channel-for-calling. Consequently, the mobile station has to send a call-connection-request a plurality of times. For this reason, there is a case that it takes considerable time until connecting to a base station having a vacant channel-for-calling.

The related art of the present invention is Japanese Unexamined Patent Publication JP2000-324553.

In the conventional mobile communications system, as mentioned above, since there is no means of the base station's notifying a mobile station of no vacant channel-for-calling, unless the mobile station which has been in the waiting state at the base station having no vacant channel receives a notification of call-connection-request refusal because of no vacant channel-for-calling, as a response to the call-connection-request from the mobile station, there is a problem that the mobile station can not recognize that no vacant channel-for-calling is existent in the base station concerned.

### SUMMARY OF THE INVENTION

It is one of objects of the present invention, in order to solve the above problem, to provide a mobile communications system in which reduction of a call-loss rate in the whole system can be realized by utilizing a vacant channel-for-calling in a neighboring base station in the case of no vacant channel-for-calling becoming existent in the base station concerned or in the case of traffic exceeding a specific level, and a mobile station can certainly connect to a base station having a vacant channel in a short time, without the mobile station's accessing a base station having no vacant channel.

According to one aspect of the present invention, a base station which continuously transmits control information to at least one communication terminal in an area in order to perform a communication control of the communication terminal, includes

a control information generating part for generating control information,

a communications part for continuously transmitting the control information generated by the control information generating part to the communication terminal in the area, and

a control information control part, in a certain case, for making the communication terminal in the area unable to recognize the control information by controlling at least one of the control information generating part and the communications part.

According to another aspect of the present invention, a base station which continuously transmits control information to at least one communication terminal in an area in order to perform a communication control of the communication terminal in the area, includes

a communications part for continuously transmitting the control information to the communication terminal in the area, and

a control information control part, in a certain case, for generating reception-stop-instruction information which instructs the communication terminal in the area to stop receiving the control information,

wherein the communications part transmits the reception-stop-instruction information generated by the control information control part to the communication terminal in the area.

According to another aspect of the present invention, a communication system includes

the first base station for managing a communication-terminal-in-first-area which exists in the first area, holding a communication channel which can be set for the communication-terminal-in-first-area, and setting the communication channel for the communication-terminal-in-first-area by receiving a setting request for the communication channel from the communication-terminal-in-first-area; and

the second base station for managing a communication-terminal-in-second-area which exists in the second area,

wherein the first base station, in a certain case, stops receiving the setting request for the communication channel from the communication-terminal-in-first-area, generates notification information which notifies that receiving the setting request for the communication channel has been stopped, and transmits the notification information generated by the first base station to the second base station, and the second base station receives the notification information transmitted from the first base station and transmits the notification information received to the communication-terminal-in-second-area.

According to another aspect of the present invention, a base station control apparatus which is connected to a plurality of base stations and controls the plurality of base stations, wherein each of the plurality of base stations has a management area as a management object, holds a communication channel which can be set for a communication terminal in its management area, and when receiving a setting request for the communication channel from the communication terminal in its management area, sets the communication channel for the communication terminal in its management area,

wherein the base station control apparatus, in the case of a specific base station having stopped receiving the setting request for the communication channel, detects that the specific base station has stopped receiving the setting request for the communication channel, generates notification information which notifies that the specific base station has stopped receiving the setting request for the communication channel, transmits the generated notification information to a base station other than the specific base station, and makes the base station other than the specific base station transmit the generated notification information to the communication terminal in its management area.

According to the present invention, for example, in the case that no vacant communication channel becomes existent or communication traffic exceeds a specific level in a base station, by making a communication terminal in the area unable to recognize control information, it is possible for the communication terminal in the area to avoid accessing the base station having no vacant communication channel or the base station whose communication traffic has exceeded a specific level. Therefore, according to the present invention, a call-loss rate can be reduced and the communication terminal in the area can be certainly connected to a base station having a vacant channel, in a short time.

The above-mentioned and other objects, features, and advantages of the present invention will be made more apparent by reference to the following detailed description when taken in conjunction with the accompanying drawings.

### BRIEF DESCRIPTION OF THE DRAWINGS

In the drawings,

FIG. 1 shows the whole structure example of a mobile communications system according to Embodiments 1 through 20;

FIG. 2 is a sequence figure showing a conventional art;

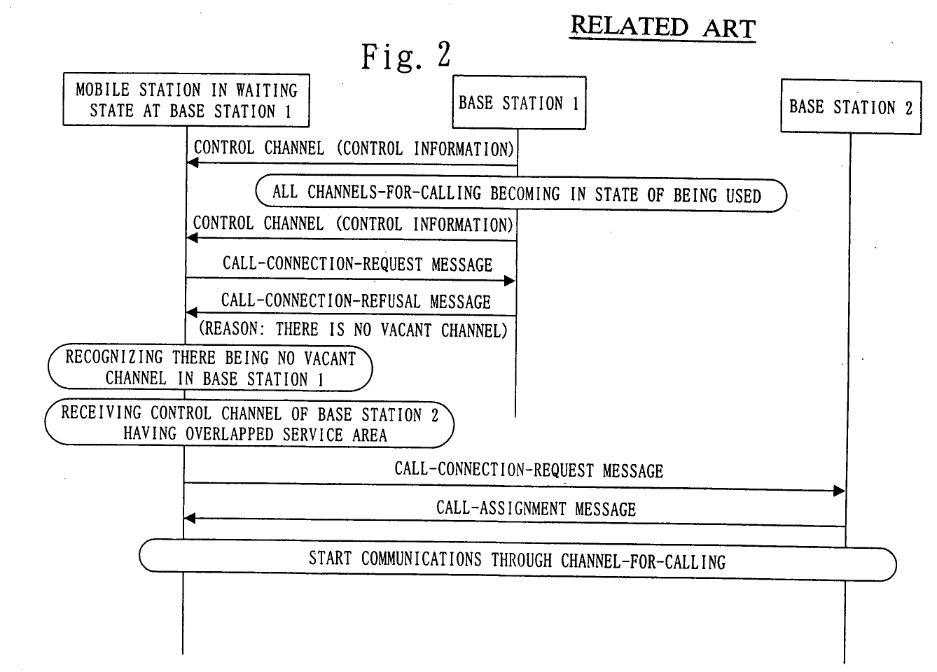

FIG. 3 shows an operation sequence according to the Embodiment 1;

FIG. 4 shows an operation sequence according to the Embodiment 2;

FIG. 5 shows an operation sequence according to the Embodiment 3;

FIG. 6 shows an operation sequence according to the Embodiment 4;

FIG. 7 shows an operation sequence according to the Embodiment 5;

FIG. 8 shows an operation sequence according to the Embodiment 6;

FIG. 9 shows an operation sequence according to the Embodiment 7;

FIG. 10 shows an operation sequence according to the Embodiment 8;

FIG. 11 shows an operation sequence according to the Embodiment 9;

FIG. 12 shows an operation sequence according to the Embodiment 10;

FIG. 13 shows an operation sequence according to the Embodiment 11;

FIG. 14 shows an operation sequence according to the Embodiment 12;

FIG. 15 shows an operation sequence according to the Embodiment 13;

FIG. 16 shows an operation sequence according to the Embodiment 14;

FIG. 17 shows an operation sequence according to the Embodiment 15;

FIG. 18 shows an operation sequence according to the Embodiment 16;

FIG. 19 shows an operation sequence according to the Embodiment 17;

FIG. 20 shows an operation sequence according to the Embodiment 18;

FIG. 21 shows an operation sequence according to the Embodiment 19;

FIG. 22 shows an operation sequence according to the Embodiment 20;

FIG. 23 shows a structure example of a base station according to Embodiment 1; and

FIG. 24 shows a structure example of a base station according to Embodiment 7.

### DETAILED DESCRIPTION OF PREFERRED EMBODIMENTS

### Embodiment 1

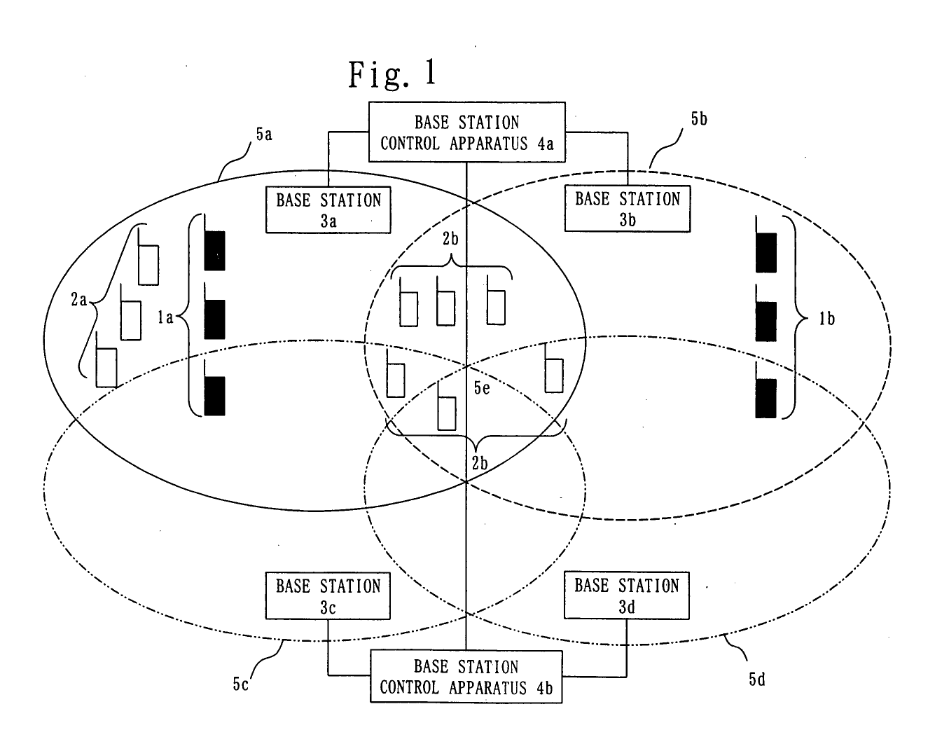

FIG. 1 shows the whole structure of a mobile communications system according to the present Embodiment. The mobile communications system according to the present Embodiment is composed of a mobile station (a communication terminal), a base station, and a base station control apparatus.

A base station 3a manages a service area 5a as a management object, a base station 3b manages a service area 5b as a management object, a base station 3c manages a service area 5c as a management object, and a base station 3d manages a service area 5d as a management object. Each base station holds channels-for-calling (communication channels) of a certain number, and sets up a channel-for-calling in a mobile station based on a request from the mobile station. It is supposed that all the channels-for-calling in the base station 3a are in a state of being used, and the base station 3b has a vacant channel-for-calling.

A mobile station 1a is connected to the base station 3a (a channel-for-calling has been set up ) through a wireless line in the service area 5a, and a mobile station 2a is in a waiting state (a channel-for-calling is not set up) at the service area 5a. A mobile station 1b is connected to the base station 3b (a channel-for-calling has been set up) through a wireless line in the service area 5b. Although a mobile station 2b is in a waiting state (a channel-for-calling is not set up) under the control of the base station 3a, it is also in the waiting state at a service area 5e which is overlapped with the service area 5b of the base station 3b having a vacant channel-for-calling.

A base station control apparatus 4a is connected to the base station 3a and the base station 3b, and controls the base station 3a and the base station 3b. A base station control apparatus 4b is connected to the base station 3c and the base station 3d, and controls the base station 3c and the base station 3d. It is supposed in here that the base station 3a and base station 3b are in the same simultaneous call area, and the base station 3c and the base station 3d are set up in the same simultaneous call area differing from that of the base station 3a and base station 3b.

In the present Embodiment, when all the channels-for-calling are in a state of being used (in the state of there being no vacant channel-for-calling) or when communication traffic of a mobile station where a channel-for-calling is set up exceeds a specific level, the base station stops transmission of the control channel (control information). Then, as it becomes impossible for the mobile station to recognize the control channel from the base station because of the transmission stop of the control channel, the mobile station receives a control channel from other base station in order to connect to it. The control channel (control information) is information transmitted for a mobile station in a waiting state. For example, it is the information for controlling a transmission timing (channel) etc. at the time of the mobile station transmitting a call-connection-request message which requests to set up a channel-for-calling. Namely, the control channel in here differs from an individual control channel for each mobile station having started communication (a channel-for-calling has been setup) at the base station.

For example, when no vacant channel-for-calling becomes existent in the base station 3a or when communication traffic of the mobile station 1a exceeds a specific level, it becomes impossible for the mobile station 2b having been in a waiting state in the service area 5e with receiving a control channel (control information) from the base station 3a, to recognize the control channel from the base station 3a, therefore, the mobile station 2b switches the control channel of the base station 3a to the control channel of the base station 3b and goes into a waiting state.

In the service area 5e, the mobile station 2b has been in a waiting state with receiving the control channel from base station 3a or the base station 3b. When no vacant channel-for-calling of the base station 3a or 3b becomes existent or when communication traffic of the mobile station 1a or 1b exceeds a specific level, it becomes impossible for the mobile station 2b to recognize the control channel from the base station 3a or the base station 3b. Therefore, the mobile station 2b switches the control channel of the base station 3a or 3b to the control channel of the base station 3c or 3d, and goes into a waiting state.

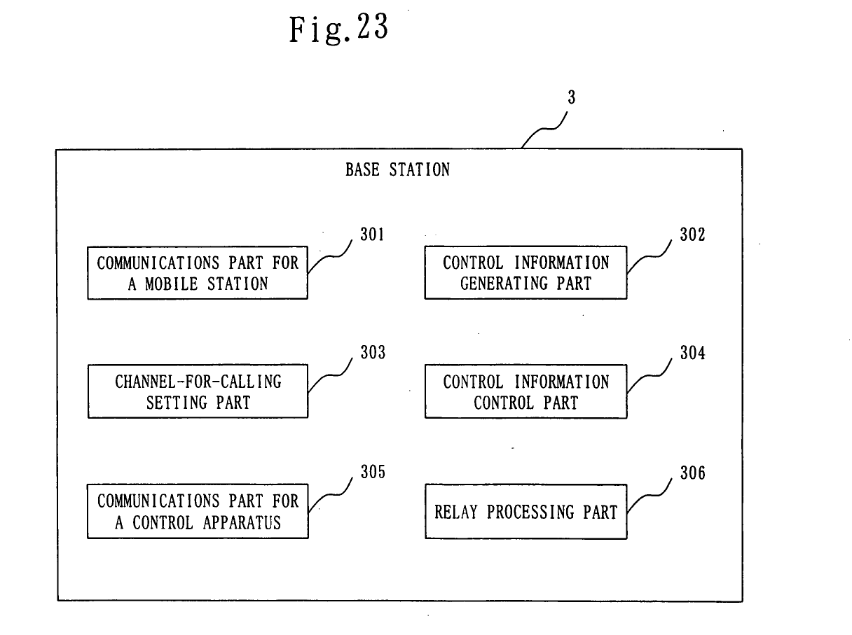

FIG. 23 shows a structure example of a base station according to the present Embodiment. A communications part 301 for a mobile station communicates with a mobile station in the area for management. The communications part 301 for a mobile station continuously transmits control information to the mobile station through a control channel. “Continuously transmitting control information” stated here indicates to periodically or always transmit the control information. Moreover, in a certain occasion, the communications part 301 for a mobile station stops transmission of the control information.

A control information generating part 302 generates control information to be transmitted to a mobile station. A channel-for-calling setting part 303 manages channels-for-calling (communication channels) of a certain number. After receiving a setup request for a channel-for-calling (communication channel) from the mobile station which has received the control information, the channel-for-calling setting part 303 sets up a channel-for-calling for the mobile station which requested the setup of the channel-for-calling.

A control information control part 304 analyzes the setting situation of the channel-for-calling or the communication traffic of the mobile station. Then, when the number of vacant channels-for-callings becomes below a specific number (for example, equal to or less than zero) or when the communication traffic exceeds a specific level, the control information control part 304 controls the communications part 301 for a mobile station and the control information generating part 302 in order that the mobile station can not recognize the control information. According to the present Embodiment, the control information control part 304 stops the transmission of the control information, by controlling the communications part 301 for a mobile station and the control information generating part 302.

A communications part 305 for a control apparatus communicates with a base station control apparatus 4. What is made by combining the communications part 301 for a mobile station and the communications part 305 for a control apparatus corresponds to a communications part. A relay processing part 306 performs relay processing for information transmitted and received on a channel-for-calling between a mobile station and the base station control apparatus 4.

In addition, only the elements for realizing the function of the base station according to the present Embodiment are shown in FIG. 23, and it is also acceptable to add elements other than the elements shown in FIG. 23.

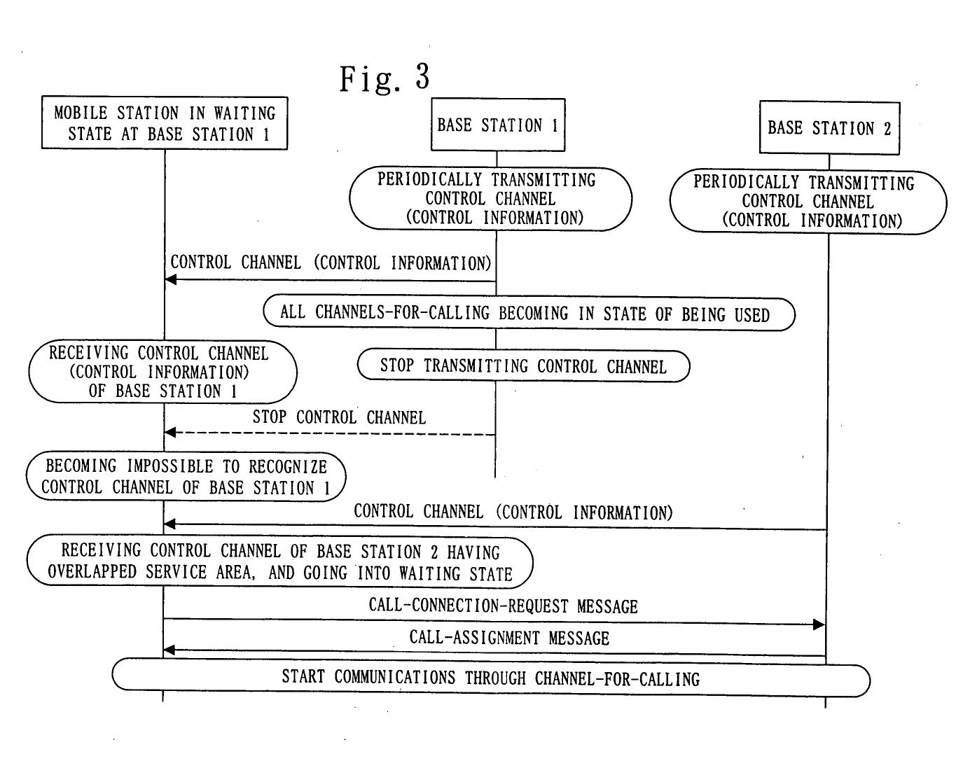

FIG. 3 shows a sequence of operations of the base station and the mobile station according to the present Embodiment. In FIG. 3, a base station 1 corresponds to the base station 3a of FIG. 1, a base station 2 corresponds to the base station 3b of FIG. 1, and a mobile station in a waiting state at the base station 1 corresponds to the mobile station 2b of FIG. 1.

The base station 1 periodically transmits control channel (control information). When all the channels-for-calling become in a state of being used (or when traffic exceeds a specific level) in the base station 1, the base station 1 stops transmitting the control channel.

It becomes impossible for the mobile station which has been in a waiting state with receiving the control channel from the base station 1 to recognize the control channel because the base station 1 stopped transmitting the control channel. Then, the mobile station performs switching in order to receive control channel of the base station 2 whose service area is overlapped with that of base station 1 and which has a vacant channel-for-calling. Then, the mobile station transmits a call-connection-request message (a setting request for a channel-for-calling) to the base station 2, and starts calling through a channel-for-calling set up by the base station 2.

In addition, a mobile station in a communicating state (a channel-for-calling has been set up) at the base station 1 can continue the communication since the individual control channel for the mobile station is maintained.

As mentioned above, the mobile communications system according to the present Embodiment has the following feature: when no vacant channel-for-calling becomes existent in one base station or when traffic exceeds a specific level, by way of the base station's stopping transmission of control channel, it becomes impossible for the mobile station in a waiting state at the base station to recognize the control channel from the base station, which makes the mobile station connect to other neighboring base station.

As mentioned above, according to the present Embodiment, it is possible to realize the mobile communications system where, in the case of no vacant channel-for-calling becoming existent or in the case of traffic exceeding a specific level, reduction of call-loss rate in the whole system can be realized by utilizing a vacant channel-for-calling in a neighboring base station and a mobile station can certainly connect to a base station having a vacant channel, in a short time without accessing a base station having no vacant channel.

### Embodiment 2

According to the present Embodiment, when all the channels-for-calling are in the state of being used (in the state of there being no vacant channel-for-calling) or when communication traffic of the mobile station where a channel-for-calling is set up exceeds a specific level, the base station changes the signal structure of a control channel (control information) and transmits the control channel.

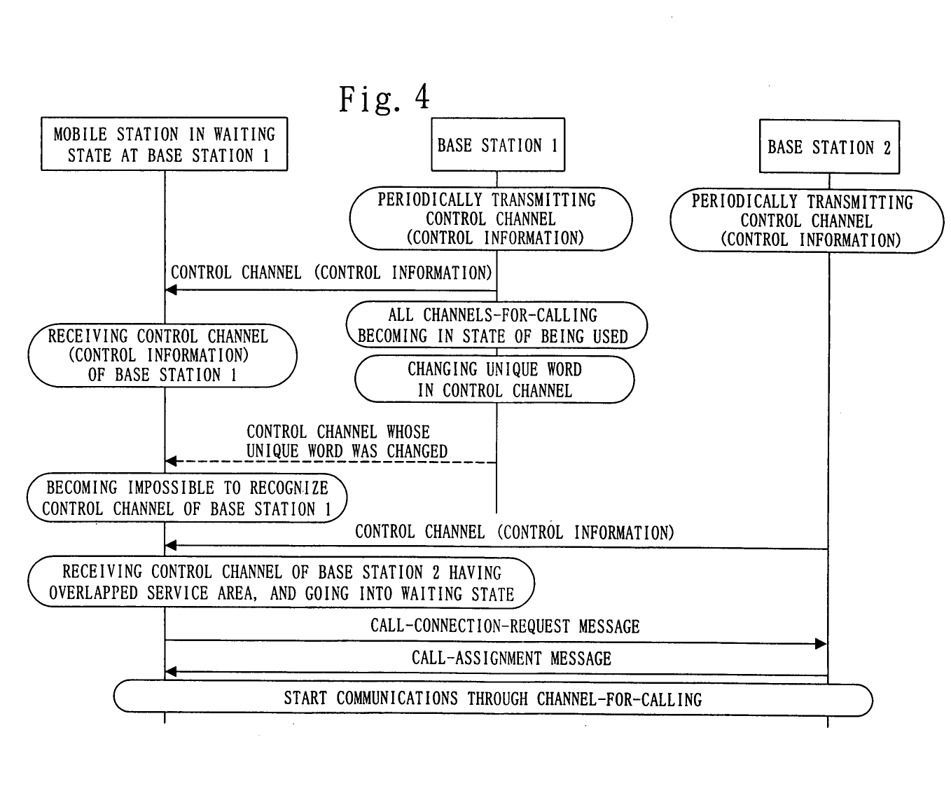

FIG. 4 shows a sequence of operations of the base station and the mobile station according to the present Embodiment. In FIG. 4, the base station 1 corresponds to the base station 3a of FIG. 1, the base station 2 corresponds to the base station 3b of FIG. 1, and a mobile station in a waiting state at the base station 1 corresponds to the mobile station 2b of FIG. 1.

When all the channels-for-calling become in a state of being used (or when traffic exceeds a specific level) in the base station 1, the base station 1 changes the unique word in the control channel (control information).

As the unique word was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling. Then, the mobile station transmits a call-connection-request message (a setting request for a channel-for-calling) to the base station 2, and starts calling through the channel-for-calling set up by the base station 2.

The structure of the base station according to the present Embodiment is the same as that shown in FIG. 23. In the present Embodiment, the control information control part 304 analyzes the setting situation of the channel-for-calling or the communication traffic of the mobile station. Then, when the number of vacant channels-for-callings becomes below a certain number (for example, equal to or less than zero) or when the communication traffic exceeds a specific level, the control information control part 304 directs the control information generating part 302 to change the unique word. Then, the control information generating part 302 changes the unique word and generates control information, and the communications part 301 for a mobile station transmits the control information whose unique word was changed to the mobile station.

As mentioned above, the mobile communications system according to the present Embodiment has the following feature: when no vacant channel-for-calling becomes existent in one base station or when traffic exceeds a specific level, by way of changing the unique word in a control channel to be transmitted from the base station and then transmitting the control channel, it becomes impossible for the mobile station in a waiting state at the base station to recognize the control channel from the base station, which makes the mobile station connect to other neighboring base station.

### Embodiment 3

According to the present Embodiment, when all the channels-for-calling are in the state of being used (in the state of there being no vacant channel-for-calling) or when communication traffic of the mobile station where a channel-for-calling is set up exceeds a specific level, the base station changes the signal structure of a control channel (control information) and transmits the control channel.

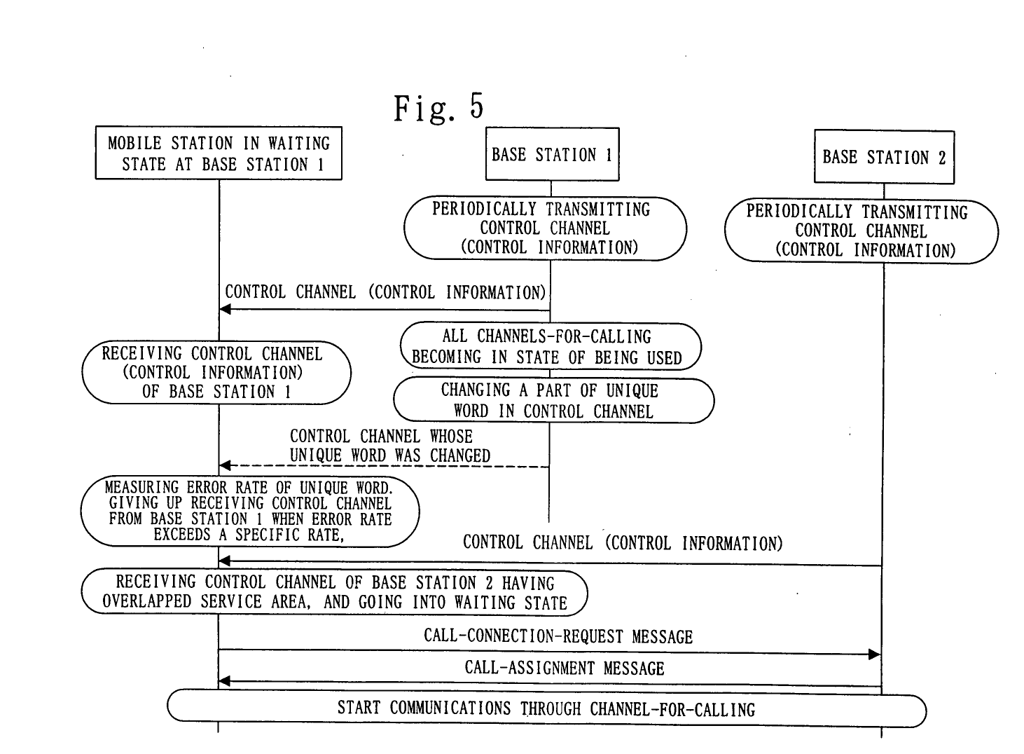

FIG. 5 shows a sequence of operations of the base station and the mobile station according to the present Embodiment. In FIG. 5, the base station 1 corresponds to the base station 3a of FIG. 1, the base station 2 corresponds to the base station 3b of FIG. 1, and a mobile station in a waiting state at the base station 1 corresponds to the mobile station 2b of FIG. 1.

When all the channels-for-calling become in a state of being used (or when traffic exceeds a specific level) in the base station 1, the base station 1 changes a part of the unique word in the control channel (control information).

Then, the mobile station which has been in a waiting state with receiving the control channel from the base station 1 measures an error rate of the unique word from the base station 1. In the case that the error rate exceeds a specific rate, namely in the case that the mobile station can not accurately recognize the control channel from the base station 1, the mobile station gives up receiving the control channel from the base station 1 and performs switching in order to receive the control channel of the base station 2 having an overlapped service area and a vacant channel-for-calling. Then, the mobile station transmits a call-connection-request message (a setting request for a channel-for-calling) to the base station 2, and starts calling through the channel-for-calling set up by the base station 2.

The structure of the base station according to the present Embodiment is the same as that shown in FIG. 23. In the present Embodiment, the control information control part 304 analyzes the setting situation of the channel-for-calling or the communication traffic of the mobile station. Then, when the number of vacant channels-for-callings becomes below a certain number (for example, equal to or less than zero) or when the communication traffic exceeds a specific level, the control information control part 304 directs the control information generating part 302 to change a part of the unique word. Then, the control information generating part 302 changes a part of the unique word and generates control information, and the communications part 301 for a mobile station transmits the control information whose a part of unique word was changed to the mobile station.

As mentioned above, the mobile communications system according to the present Embodiment has the following feature: when no vacant channel-for-calling becomes existent in one base station or when traffic exceeds a specific level, by way of changing a part of the unique word in a control channel to be transmitted from the base station and then transmitting the control channel, the mobile station in a waiting state at the base station connects to other neighboring base station, depending upon the error rate of the unique word in the control channel.

### Embodiment 4

According to the present Embodiment, when all the channels-for-calling are in the state of being used (in the state of there being no vacant channel-for-calling) or when communication traffic of the mobile station where a channel-for-calling is set up exceeds a specific level, the base station changes the signal structure of a control channel (control information) and transmits the control channel.

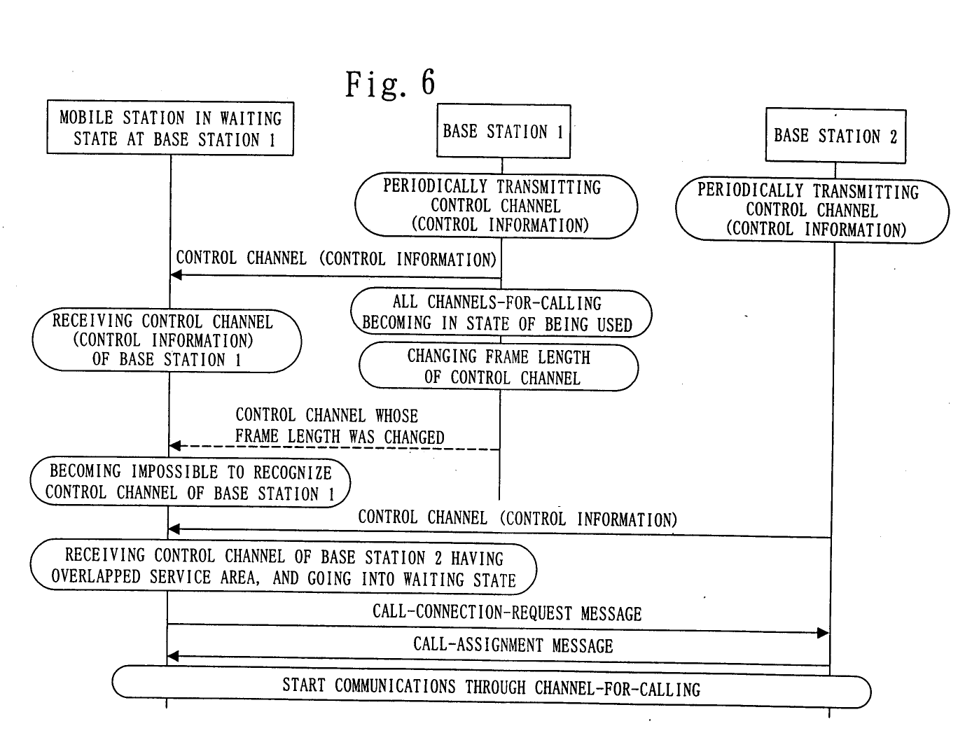

FIG. 6 shows a sequence of operations of the base station and the mobile station according to the present Embodiment. In FIG. 6, the base station 1 corresponds to the base station 3a of FIG. 1, the base station 2 corresponds to the base station 3b of FIG. 1, and a mobile station in a waiting state at the base station 1 corresponds to the mobile station 2b of FIG. 1.

When all the channels-for-calling become in a state of being used (or when traffic exceeds a specific level) in the base station 1, the base station 1 changes the frame length of the control channel (control information).

As the frame length from the base station 1 was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling. Then, the mobile station transmits a call-connection-request message (a setting request for a channel-for-calling) to the base station 2, and starts calling through the channel-for-calling set up by the base station 2.

The structure of the base station according to the present Embodiment is the same as that shown in FIG. 23. In the present Embodiment, the control information control part 304 analyzes the setting situation of the channel-for-calling or the communication traffic of the mobile station. Then, when the number of vacant channels-for-callings becomes below a certain number (for example, equal to or less than zero) or when the communication traffic exceeds a specific level, the control information control part 304 directs the control information generating part 302 to change the frame length. Then, the control information generating part 302 changes the frame length and generates control information, and the communications part 301 for a mobile station transmits the control information whose frame length was changed to the mobile station.

As mentioned above, the mobile communications system according to the present Embodiment has the following feature: when no vacant channel-for-calling becomes existent in one base station or when traffic exceeds a specific level, by way of changing the frame length of the control channel to be transmitted from the base station, it becomes impossible for the mobile station in a waiting state at the base station to recognize the control channel from the base station, which makes the mobile station connect to other neighboring base station.

### Embodiment 5

According to the present Embodiment, when all the channels-for-calling are in the state of being used (in the state of there being no vacant channel-for-calling) or when communication traffic of the mobile station where a channel-for-calling is set up exceeds a specific level, the base station changes the signal structure of a control channel (control information) and transmits the control channel.

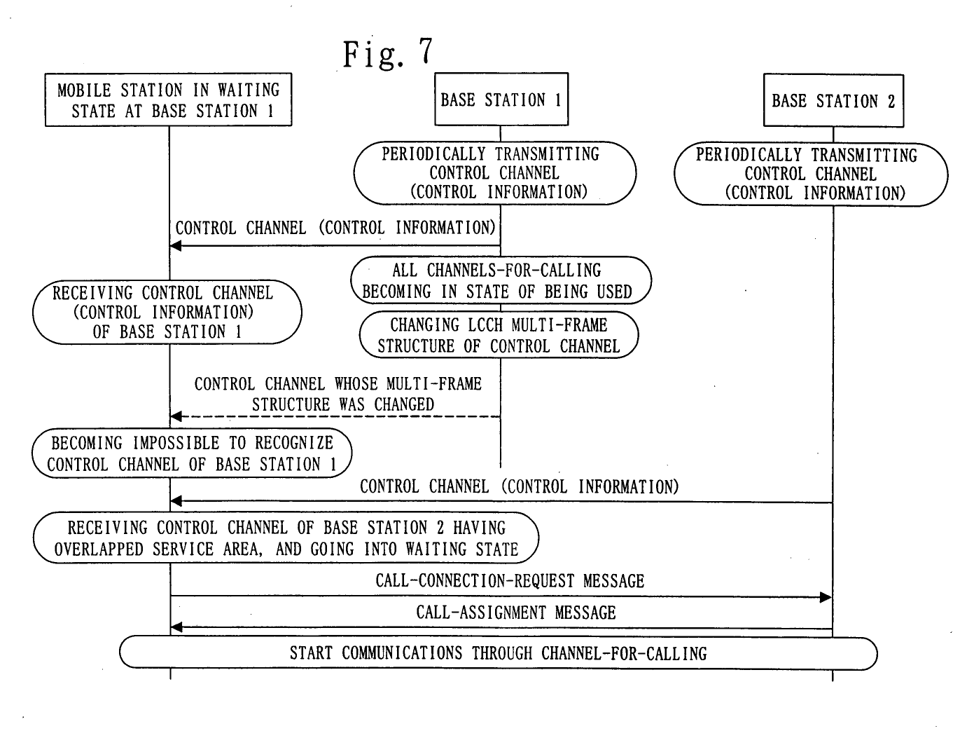

FIG. 7 shows a sequence of operations of the base station and the mobile station according to the present Embodiment. In FIG. 7, the base station 1 corresponds to the base station 3a of FIG. 1, the base station 2 corresponds to the base station 3b of FIG. 1, and a mobile station in a waiting state at the base station 1 corresponds to the mobile station 2b of FIG. 1.

When all the channels-for-calling become in a state of being used (or when traffic exceeds a specific level) in the base station 1, the base station 1 changes the LCCH (Logical Control CHannel) multi-frame structure of the control channel (control information).

As the multi-frame structure from the base station 1 was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling. Then, the mobile station transmits a call-connection-request message (a setting request for a channel-for-calling) to the base station 2, and starts calling through the channel-for-calling set up by the base station 2.

The structure of the base station according to the present Embodiment is the same as that shown in FIG. 23. In the present Embodiment, the control information control part 304 analyzes the setting situation of the channel-for-calling or the communication traffic of the mobile station. Then, when the number of vacant channels-for-callings becomes below a certain number (for example, equal to or less than zero) or when the communication traffic exceeds a specific level, the control information control part 304 directs the control information generating part 302 to change the LCCH multi-frame structure. Then, the control information generating part 302 changes the LCCH multi-frame structure and generates control information, and the communications part 301 for a mobile station transmits the control information whose LCCH multi-frame structure was changed to the mobile station.

As mentioned above, the mobile communications system according to the present Embodiment has the following feature: when no vacant channel-for-calling becomes existent in one base station or when traffic exceeds a specific level, by way of changing the LCCH multi-frame structure of the control channel to be transmitted from the base station, it becomes impossible for the mobile station in a waiting state at the base station to recognize the control channel from the base station, which makes the mobile station connect to other neighboring base station.

### Embodiment 6

According to the present Embodiment, when all the channels-for-calling are in the state of being used (in the state of there being no vacant channel-for-calling) or when communication traffic of the mobile station where a channel-for-calling is set up exceeds a specific level, the base station changes the signal structure of a control channel (control information) and transmits the control channel.

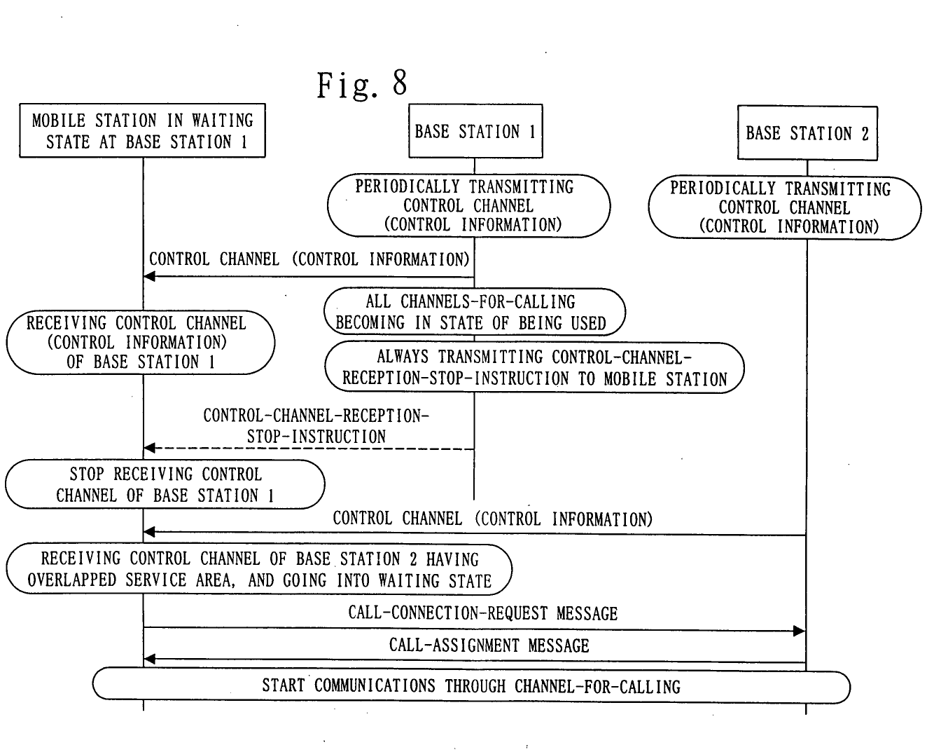

FIG. 8 shows a sequence of operations of the base station and the mobile station according to the present Embodiment. In FIG. 8, the base station 1 corresponds to the base station 3a of FIG. 1, the base station 2 corresponds to the base station 3b of FIG. 1, and a mobile station in a waiting state at the base station 1 corresponds to the mobile station 2b of FIG. 1.

When all the channels-for-calling become in a state of being used (or when traffic exceeds a specific level) in the base station 1, the base station 1 always transmits a control-channel-reception-stop-instruction (reception-stop-instruction information), which instructs the mobile station to stop receiving the control channel (control information), to the mobile station.

When the mobile station, which has been in a waiting state with receiving the control channel from the base station 1, receives the control-channel-reception-stop-instruction from the base station 1, the mobile station stops receiving the control channel from the base station 1. Then, the mobile station performs switching in order to receive the control channel of the base station 2 having an overlapped service area and a vacant channel-for-calling. Then, the mobile station transmits a call-connection-request message (a setting request for a channel-for-calling) to the base station 2, and starts calling through the channel-for-calling set up by the base station 2.

The structure of the base station according to the present Embodiment is the same as that shown in FIG. 23. In the present Embodiment, the control information control part 304 analyzes the setting situation of the channel-for-calling or the communication traffic of the mobile station. Then, when the number of vacant channels-for-callings becomes below a certain number (for example, equal to or less than zero) or when the communication traffic exceeds a specific level, the control information control part 304 generates a control-channel-reception-stop-instruction, and the communications part 301 for a mobile station transmits the control-channel-reception-stop-instruction to the mobile station.

In the above explanation, the base station 1 transmits a control-channel-reception-stop-instruction which instructs the mobile station to stop receiving the control channel. However, it is also acceptable that the base station 1 transmits not only the control-channel-reception-stop-instruction instructing the mobile station to stop receiving the control channel but also a control-channel-switching-instruction instructing the mobile station to switch the control channel.

As mentioned above, the mobile communications system according to the present Embodiment has the following feature: when no vacant channel-for-calling becomes existent in one base station or when traffic exceeds a specific level, by way of always transmitting a control-channel-reception-stop-instruction from the base station to the mobile station in a waiting state, the mobile station in the waiting state at the base station connects to other neighboring base station.

### Embodiment 7

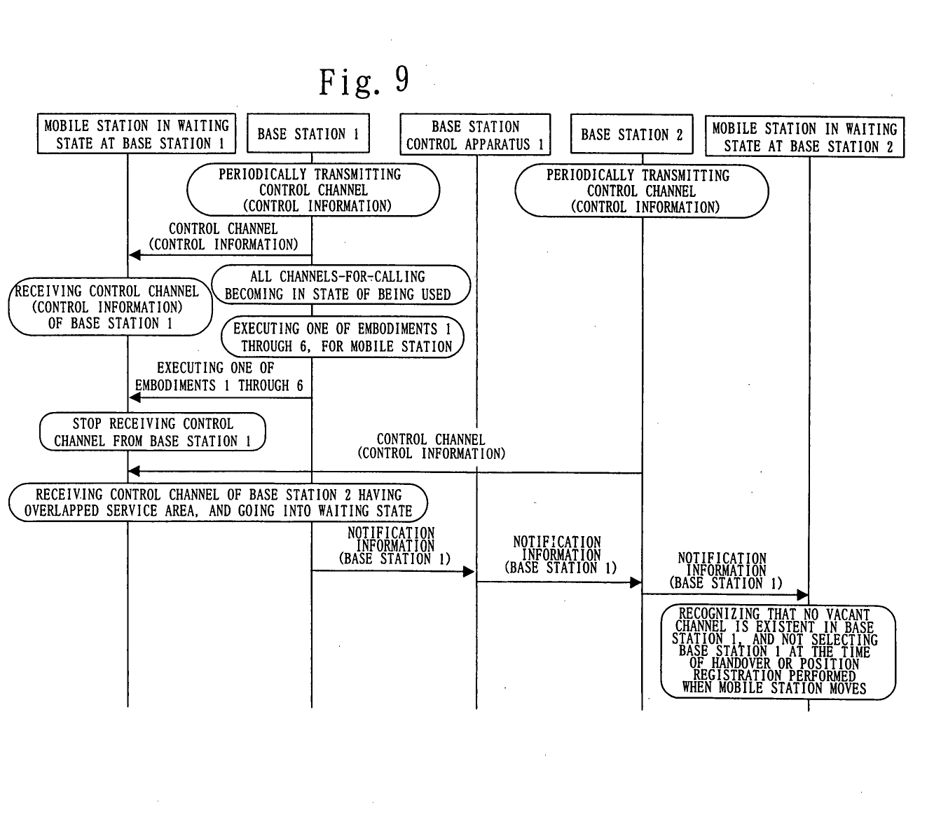

FIG. 9 shows a sequence of operations of the base station, the mobile station, and the base station control apparatus according to the present Embodiment. In FIG. 9, the base station 1 corresponds to the base station 3a of FIG. 1, the base station 2 corresponds to the base station 3b of FIG. 1, and a base station control apparatus 1 corresponds to the base station control apparatus 4a of FIG. 1. The mobile station in a waiting state at the base station 1 corresponds to the mobile station which receives the control channel from the base station 3a, among the mobile stations 2b of FIG. 1. The mobile station in a waiting state at the base station 2 corresponds to the mobile station which receives the control channel from the base station 3b, among the mobile stations 2b of FIG. 1.

Moreover, the base station 1 corresponds to the first base station, and the base station 2 corresponds to the second base station. The mobile station in a waiting state at the base station 1 corresponds to a communication-terminal-in-first-area, and the mobile station in a waiting state at the base station 2 corresponds to a communication-terminal-in-second-area.

When all the channels-for-calling become in a state of being used (or when traffic exceeds a specific level) in the base station 1, the base station 1 executes one of the processing described in Embodiments 1 through 6 for the mobile station. Thereby, the base station stops receiving a call-connection-request message (a setting request for a communication channel).

The mobile station which is in a waiting state at the base station 1 stops receiving the control channel from the base station 1 because the base station 1 executes one of the processing described in Embodiments 1 through 6. Then, the mobile station performs switching in order to receive the control channel of the base station 2 having an overlapped service area and a vacant channel-for-calling.

The base station 1 generates notification information which notifies that receiving a call-connection-request message (a setting request for a communication channel) is stopped. Then, the base station 1 transmits the notification information to the base station 2 connected to the base station control apparatus 1 and is in the same simultaneous call area, through the base station control apparatus 1.

Receiving the notification information from the base station control apparatus 1, the base station 2 transmits the notification information to a mobile station in a waiting state at the base station 2, and notifies the mobile station that the base station 1 has stopped receiving a call-connection-request message (a setting request for a communication channel).

Thereby, the mobile station in a waiting state at the base station 2 does not select the base station 1 at the time of handover or a location registration performed when the mobile station moves to other cell. Then, the mobile station connects to other base station which can receive a call-connection-request message (a setting request for a communication channel).

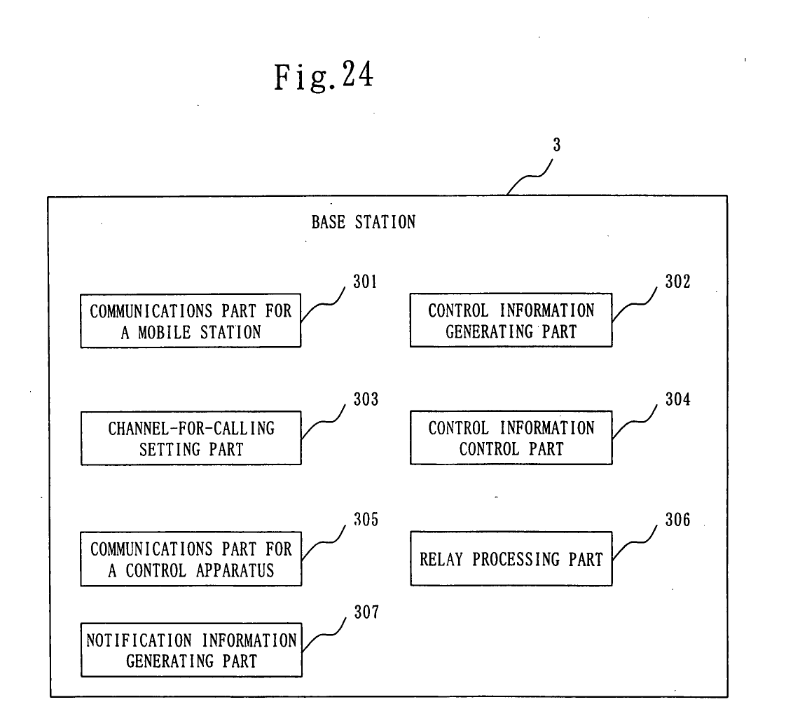

FIG. 24 shows a structure example of the base station according to the present Embodiment. As the structure elements 301 through 306 in FIG. 24 are the same as those in FIG. 23, explanations for them are omitted.

At the time of one of the processing described in Embodiments 1 through 6 is executed by the control information control part 304, a notification information generating part 307 generates notification information which notifies that receiving a call-connection-request message (a setting request for a communication channel) is stopped. The notification information generated by the notification information generating part 307 is transmitted to a base station control apparatus by the communications part 305 for a control apparatus.

As mentioned above, the mobile communications system according to the present Embodiment has the following feature: when no vacant channel-for-calling becomes existent in one base station or when traffic exceeds a specific level, after executing one of the processing described in Embodiments 1 through 6, a notification that the base station has stopped receiving a call-connection-request message (a setting request for a communication channel) is transmitted to a plurality of base stations in the same simultaneous call area, through the base station control apparatus. Receiving the notification, each of the plurality of base stations notifies mobile stations in a waiting state at each of the plurality of base stations, that the base station has stopped receiving a call-connection-request message (a setting request for a communication channel). Thereby, the mobile stations in the waiting state or the mobile stations in a communicating state under the control of each of the plurality of base stations do not select the base station as a connection party, at the time of handover or a location registration performed when the mobile stations move to other cell.

### Embodiment 8

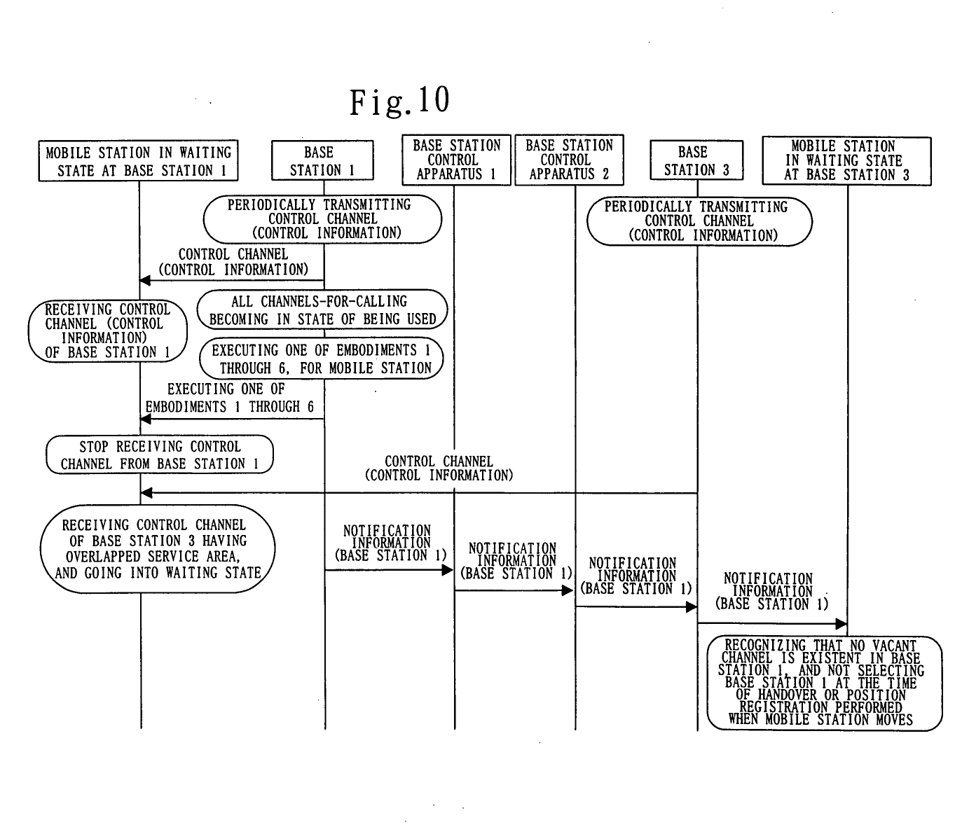

FIG. 10 shows a sequence of operations of the base station, the mobile station, and the base station control apparatus according to the present Embodiment. In FIG. 10, the base station 1 corresponds to the base station 3a of FIG. 1, the base station 3 corresponds to the base station 3c or 3d of FIG. 1, the base station control apparatus 1 corresponds to the base station control apparatus 4a of FIG. 1, and the base station control apparatus 2 corresponds to the base station control apparatus 4b of FIG. 1. The mobile station in a waiting state at the base station 1 corresponds to one of the mobile stations 2b of FIG. 1, which receives the control channel from the base station 3a, and the mobile station in a waiting state at the base station 3 corresponds to one of the mobile stations 2b of FIG. 1, which receives the control channel from the base station 3c or 3d.

Moreover, the base station 1 corresponds to the first base station, and the base station 3 corresponds to the second base station. The base station control apparatus 1 corresponds to the first base station control apparatus, and the base station control apparatus 2 corresponds to the second base station control apparatus. The mobile station in a waiting state at the base station 1 corresponds to a communication-terminal-in-first-area, and the mobile station in a waiting state at the base station 3 corresponds to a communication-terminal-in-second-area.

When all the channels-for-calling become in a state of being used (or when traffic exceeds a specific level) in the base station 1, the base station 1 executes one of the processing described in Embodiments 1 through 6 for the mobile station. Thereby, the base station 1 stops receiving a call-connection-request message (a setting request for a communication channel).

The mobile station in a waiting state at the base station 1 stops receiving the control channel from the base station 1 because the base station 1 executed one of the processing described in Embodiments 1 through 6, and performs switching in order to receive the control channel of the base station (ex. the base station 3) having an overlapped service area and a vacant channel-for-calling.

The base station 1 generates notification information which notifies that the base station 1 has stopped receiving a call-connection-request message (a setting request for a communication channel). Then, the base station 1 transmits the notification information to the base station 3 which is connected to the base station control apparatus 2 and is in a different simultaneous call area, through the base station control apparatuses 1 and 2.

Receiving the notification information from the base station control apparatus 2, the base station 3 transmits the notification information to mobile station in a waiting state at the base station 3, and notifies the mobile station that the base station 1 has stopped receiving a call-connection-request message (a setting request for a communication channel). Thereby, the mobile station in a waiting state at the base station 3 connects to other base station having a vacant channel-for-talking, without selecting the base station 1, at the time of handover or a location registration performed when the mobile station moves to other cell.

The structure of the base station according to the present Embodiment is the same as that shown in FIG. 24. At the time of one of the processing described in Embodiments 1 through 6 is executed by the control information control part 304, the notification information generating part 307 generates notification information and the communications part 305 for a control apparatus transmits the notification information to the base station control apparatus.

As mentioned above, the mobile communications system according to the present Embodiment has the following feature: when no vacant channel-for-calling becomes existent or traffic exceeds a specific level in one base station, after executing one of the processing described in Embodiments 1 through 6 and the processing of Embodiment 7, a notification that the base station has stopped receiving a call-connection-request message (a setting request for a communication channel) is transmitted to a plurality of base stations in the simultaneous call area different from that of the base station, through the base station control apparatus which controls the simultaneous call area different from that of the base station. Receiving the notification, each of the plurality of base stations notifies mobile stations in a waiting state at each of the plurality of base stations that the base station has stopped receiving a call-connection-request message (a setting request for a communication channel). Thereby, the mobile stations in a waiting state or in a communicating state under the control of each of the plurality of base stations do not select the base station as a connection party, at the time of handover or a location registration performed when the mobile stations move to other cell.

### Embodiment 9

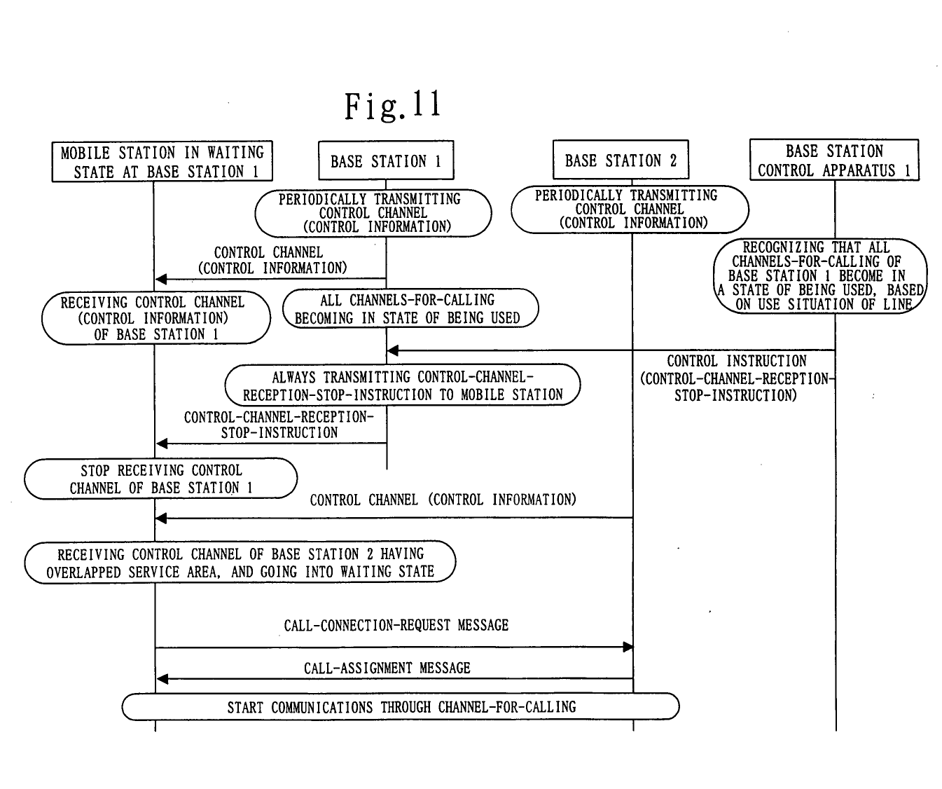

FIG. 11 shows a sequence of operations of the base station, the mobile station, and the base station control apparatus according to the present Embodiment. In FIG. 11, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1, based on a usage situation of the line. Then, the base station control apparatus 1 generates a control instruction which instructs the base station 1 to generate a control-channel-reception-stop-instruction (reception-stop-instruction information) directing a mobile station in a waiting state at the base station 1 to stop receiving the control channel (control information) from the base station 1. Then, the base station control apparatus 1 transmits the generated control instruction to the base station 1.

Then, the base station 1 generates a control-channel-reception-stop-instruction (reception-stop-instruction information) based on the control instruction, and transmits it to the mobile station in a waiting state at the base station 1.

Receiving the control-channel-reception-stop-instruction from the base station 1, the mobile station, which has been in a waiting state with receiving the control channel from the base station 1, stops receiving the control channel from the base station 1 and performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives the control instruction from the base station control apparatus, the control information control part 304 generates a control-channel-reception-stop-instruction based on the control instruction, and the communications part 301 for a mobile station transmits the control-channel-reception-stop-instruction to a mobile station.

In the above explanation, the base station 1 transmits a control-channel-reception-stop-instruction which instructs to stop receiving the control channel. However, it is also acceptable that the base station 1 transmits not only the control-channel-reception-stop-instruction instructing to stop receiving the control channel but also a control-channel-switching-instruction instructing to switch the control channel.

In the above explanation, the base station control apparatus 1 generates a control instruction which instructs the base station 1 to generate a control-channel-reception-stop-instruction, and the base station 1 generates the control-channel-reception-stop-instruction. However, it is also acceptable that the base station control apparatus 1 generates the control-channel-reception-stop-instruction itself, and the base station 1 converts (regenerates) the control-channel-reception-stop-instruction transmitted from the base station control apparatus 1 into an instruction for wireless transmission and transmits it to a mobile station.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station always transmits a control-channel-reception-stop-instruction to a mobile station in a waiting state. Therefore, the mobile station in the waiting state at the base station connects to other neighboring base station.

### Embodiment 10

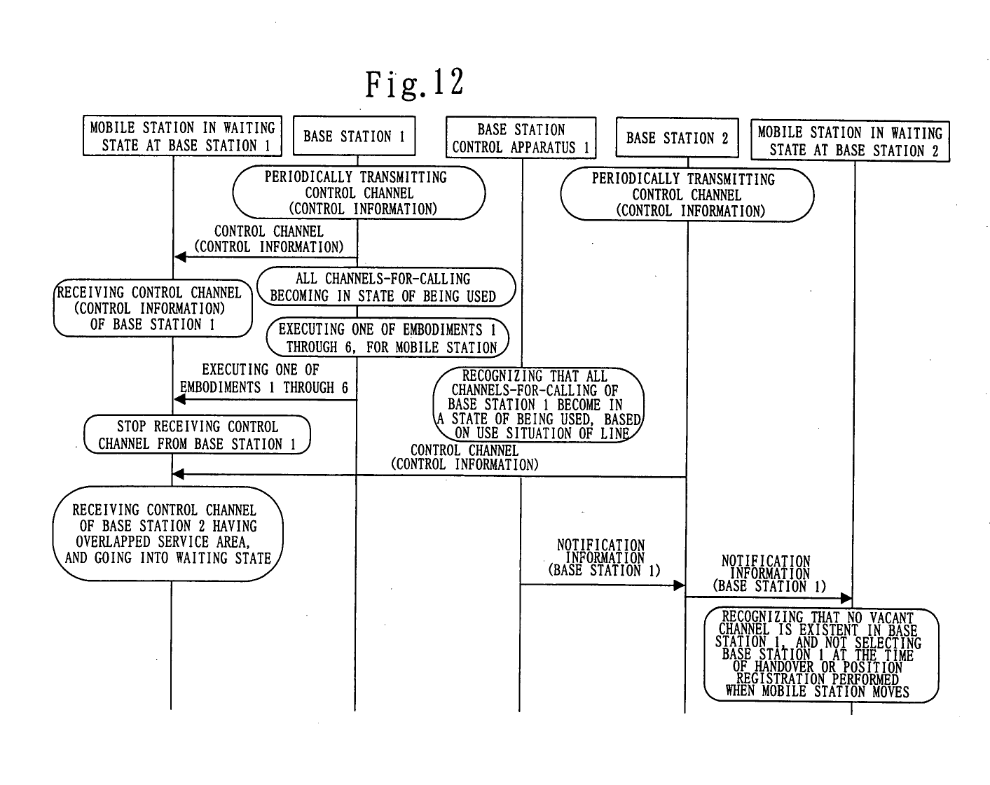

FIG. 12 shows a sequence of operations of the base station, the mobile station, and the base station control apparatus according to the present Embodiment. In FIG. 12, the base station 1 corresponds to the base station 3a of FIG. 1, the base station 2 corresponds to the base station 3b of FIG. 1, the base station control apparatus 1 corresponds to the base station control apparatus 4a of FIG. 1, the mobile station in a waiting state at the base station 1 corresponds to one of the mobile stations 2b of FIG. 1, which receives the control channel from the base station 3a, and the mobile station in a waiting state at the base station 2 corresponds to one of mobile stations 2b of FIG. 1, which receives the control channel from the base station 3b.

When all the channels-for-calling become in a state of being used (or when traffic exceeds a specific level) in the base station 1, the base station 1 executes one of the processing described in Embodiments 1 through 6 for the mobile station. Thereby, the base station 1 stops receiving a call-connection-request message (a setting request for a communication channel).

Based on a usage situation of the line, the base station control apparatus 1 recognizes that all the channels-for-calling become in a state of being used (or traffic exceeds a specific level) in the base station 1 and the base station 1 has stopped receiving a call-connection-request message (a setting request for a communication channel). The base station control apparatus 1 generates notification information which notifies that the base station 1 has stopped receiving a call-connection-request message (a setting request for a communication channel). Then, the base station control apparatus 1 transmits the notification information to the base station 2 which is connected to the base station control apparatus 1 and is in the same simultaneous call area.

Receiving the notification information from the base station control apparatus 1, the base station 2 transmits the notification information to mobile station in a waiting state at the base station 2, and notifies the mobile station that the base station 1 has stopped receiving a call-connection-request message (a setting request for a communication channel).

Thereby, the mobile station in a waiting state at the base station 2 connects to other base station which can receive the call-connection-request message (a setting request for a communication channel), without selecting the base station 1, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, the base station executes one of the processing described in Embodiments 1 through 6. The base station control apparatus which controls the base station notifies a plurality of base stations in the same simultaneous call area that the base station has stopped receiving a call-connection-request message. Receiving the notification, each of the plurality of base stations notifies mobile stations in a waiting state at each of the plurality of base stations that the base station has stopped receiving a call-connection-request message. Thereby, the mobile stations in a waiting state or in a communicating state under the control of each of the plurality of base stations do not select the base station as a connection party, at the time of handover or a location registration performed when the mobile stations move to other cell.

### Embodiment 11

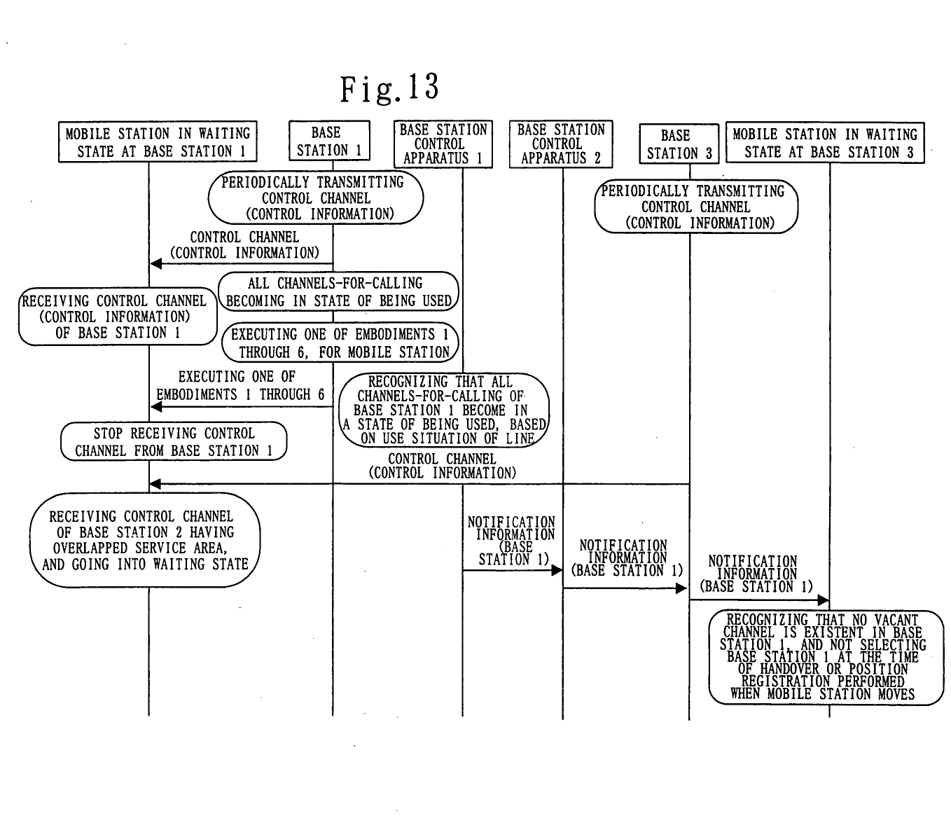

FIG. 13 shows a sequence of operations of the base station, the mobile station, and the base station control apparatus according to the present Embodiment. In FIG. 13, the base station 1 corresponds to the base station 3a of FIG. 1, the base station 3 corresponds to the base station 3c or 3d of FIG. 1, the base station control apparatus 1 corresponds to the base station control apparatus 4a of FIG. 1, and the base station control apparatus 2 corresponds to the base station control apparatus 4b of FIG. 1. The mobile station in a waiting state at the base station 1 corresponds to one of the mobile stations 2b of FIG. 1, which receives the control channel from the base station 3a, and the mobile station in a waiting state at the base station 3 corresponds to one of the mobile stations 2b of FIG. 1, which receives the control channel from the base station 3c or 3d.

When all the channels-for-calling become in a state of being used (or when traffic exceeds a specific level) in the base station 1, the base station 1 executes one of the processing described in Embodiments 1 through 6 for the mobile station. Thereby, the base station 1 stops receiving a call-connection-request message (a setting request for a communication channel).

Based on a usage situation of the line, the base station control apparatus 1 recognizes that all the channels-for-calling become in a state of being used (or traffic exceeds a specific level) in the base station 1 and the base station 1 has stopped receiving a call-connection-request message (a setting request for a communication channel). The base station control apparatus 1 generates notification information which notifies that the base station 1 has stopped receiving a call-connection-request message (a setting request for a communication channel). Then, the base station control apparatus 1 transmits the notification information to the base station 3 which is connected to the base station control apparatus 2 and is in a different simultaneous call area, through the base station control apparatus 2.

Receiving the notification information from the base station control apparatus 2, the base station 3 transmits the notification information to mobile station in a waiting state at the base station 3, and notifies the mobile station that the base station 1 has stopped receiving a call-connection-request message (a setting request for a communication channel).

Thereby, the mobile station in a waiting state at the base station 3 connects to other base station having a vacant channel-for-calling, without selecting the base station 1, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, one of the processing described in Embodiments 1 through 6, and Embodiment 7 or 10 are executed. Then, through the base station control apparatus which controls a different simultaneous call area from that of the base station, a notification that the base station has stopped receiving a call-connection-request message is transmitted to a plurality of base stations in the different simultaneous call area. Receiving the notification, each of the plurality of base stations notifies mobile stations in a waiting state at each of the plurality of base stations that there is no vacant channel-for-calling in the base station. Thereby, the mobile stations in a waiting state or in a communicating state under the control of each of the plurality of base stations do not select the base station as a connection party, at the time of handover or a location registration performed when the mobile stations move to other cell.

### Embodiment 12

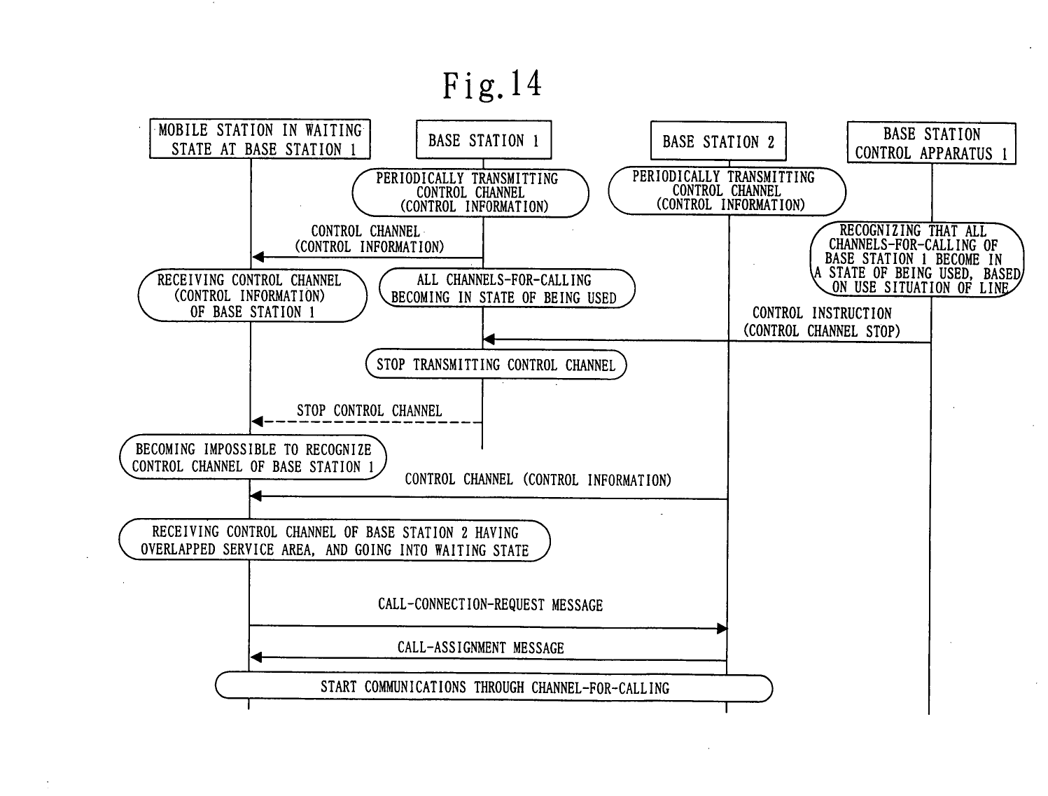

FIG. 14 shows a sequence of operations of the base station, the mobile station, and the base station control apparatus according to the present Embodiment. In FIG. 14, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1. Then, the base station control apparatus 1 transmits a control instruction which instructs the base station 1 to stop transmitting the control channel (control information).

Receiving the control instruction from the base station control apparatus 1, the base station 1 stops transmitting the control channel (control information) to the mobile station, based on the control instruction.

As transmitting the control channel (control information) from the base station 1 is stopped, it becomes impossible for the mobile station which has been in a waiting state with receiving the control channel from the base station 1 to recognize the control channel. Then, the mobile station performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives a control instruction from the base station control apparatus, the control information control part 304 instructs the communications part 301 for a mobile station to stop transmitting the control channel, based on the control instruction, and the communications part 301 for a mobile station stops transmitting the control channel based on the control instruction of the control information control part 304.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station stops transmitting the control channel. Then, the mobile station in a waiting state at the base station connects to other neighboring base station.

### Embodiment 13

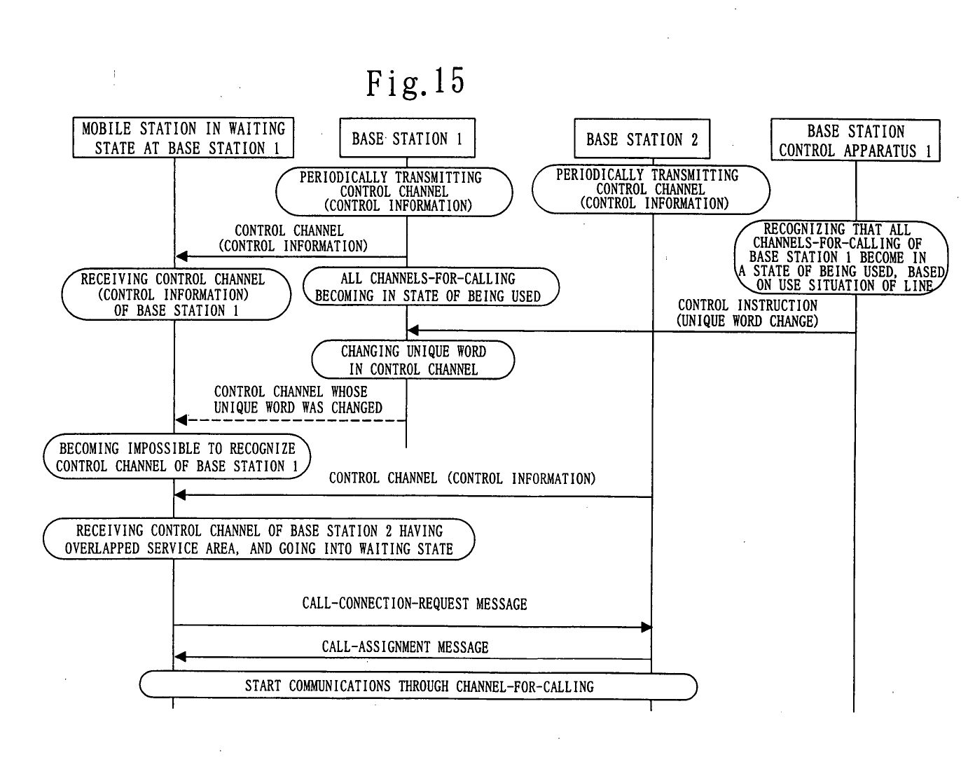

FIG. 15 shows a sequence of operations of the base station, the mobile station, and the base station control apparatus according to the present Embodiment. In FIG. 15, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1. Then, the base station control apparatus 1 transmits a control instruction which instructs the base station 1 to change the unique word.

Receiving the control instruction from the base station control apparatus 1, the base station 1 changes the unique word in the control channel (control information) for the mobile station, based on the control instruction, and transmits the control channel whose unique word was changed to the mobile station.

As the unique word from the base station 1 was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives an control instruction from the base station control apparatus, the control information control part 304 instructs the control information generating part 302 to change the unique word based on the control instruction, the control information generating part 302 generates control information with changing the unique word based on the instruction of the control information control part 304, and the communications part 301 for a mobile station transmits the control channel whose unique word was changed to the mobile station.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station transmits the control channel whose unique word was changed. Then, it becomes impossible for the mobile station which has been in a waiting state to recognize the control channel from the base station. Then, the mobile station connects to other neighboring base station.

### Embodiment 14

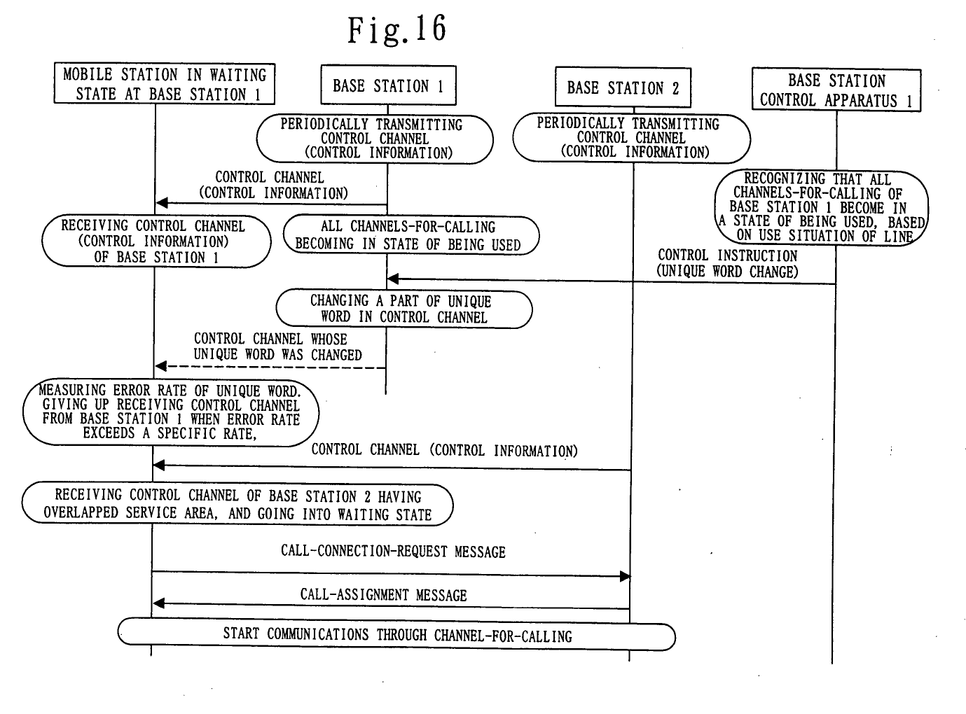

FIG. 16 shows a sequence of operations of the base station, the mobile station, and the base station control apparatus according to the present Embodiment. In FIG. 16, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1. Then, the base station control apparatus 1 transmits a control instruction which instructs the base station 1 to change a part of the unique word.

Receiving the control instruction from the base station control apparatus 1, the base station 1 changes a part of the unique word in the control channel (control information) for the mobile station based on the control instruction.

Then, the mobile station which has been in a waiting state with receiving the control channel from the base station 1 measures an error rate of the unique word from the base station 1. In the case that the error rate exceeds a specific rate, namely in the case that it becomes impossible for the mobile station to accurately recognize the control channel from the base station 1, the mobile station gives up receiving the control channel from the base station 1 and performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives a control instruction from the base station control apparatus, the control information control part 304 instructs the control information generating part 302 to change a part of the unique word based on the control instruction, the control information generating part 302 generates control information with changing a part of the unique word based on the instruction of the control information control part 304, and the communications part 301 for a mobile station transmits the control channel whose part of unique word was changed to the mobile station.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station changes a part of the unique word in the control channel and transmits the control channel whose part of the unique word was changed. Then the mobile station in a waiting state at the base station connects to other neighboring base station, depending upon the error rate of the unique word in the control channel from the base station.

### Embodiment 15

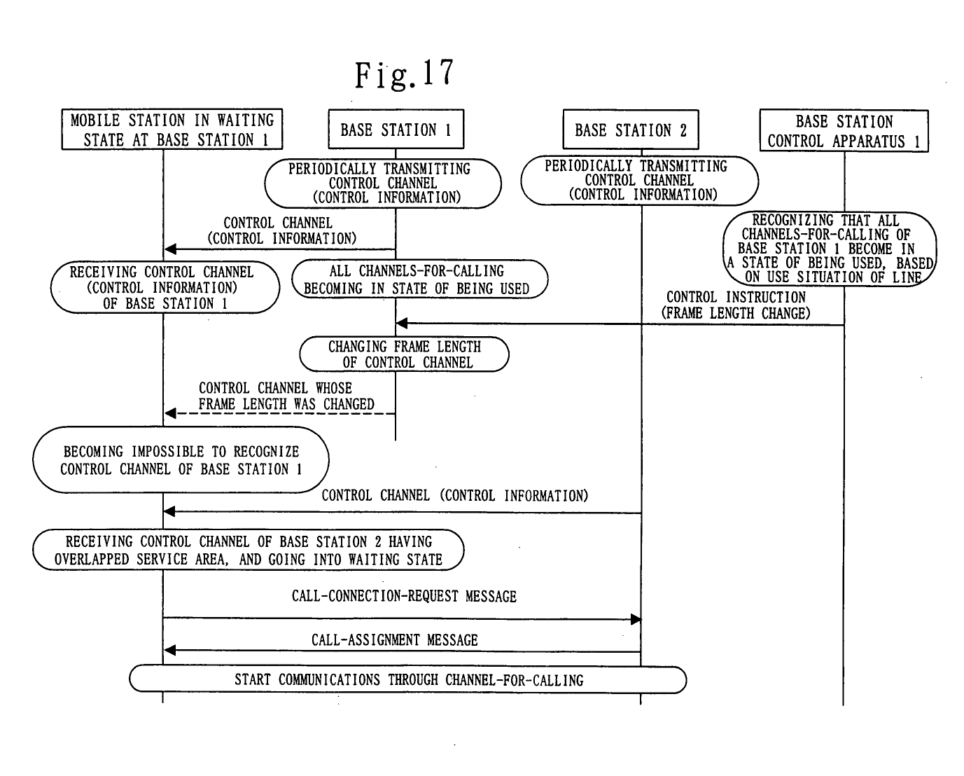

FIG. 17 shows a sequence of operations of the base station, the mobile station, and the base station control apparatus according to the present Embodiment. In FIG. 17, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1. Then, the base station control apparatus 1 transmits a control instruction which instructs the base station 1 to change the frame length of the control channel (control information).

Receiving the control instruction from the base station control apparatus 1, the base station 1 changes the frame length of the control channel (control information) based on the control instruction, and transmits it.

As the frame length of the control channel from the base station 1 was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives a control instruction from the base station control apparatus, the control information control part 304 instructs the control information generating part 302 to change the frame length based on the control instruction, the control information generating part 302 generates control information with changing the frame length based on the instruction of the control information control part 304, and the communications part 301 for a mobile station transmits the control channel whose frame length was changed to the mobile station.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station transmits the control channel whose frame length was changed. Then, it becomes impossible for the mobile station which has been in a waiting state in the base station to recognize the control channel from the base station. Then, the mobile station connects to other neighboring base station.

### Embodiment 16

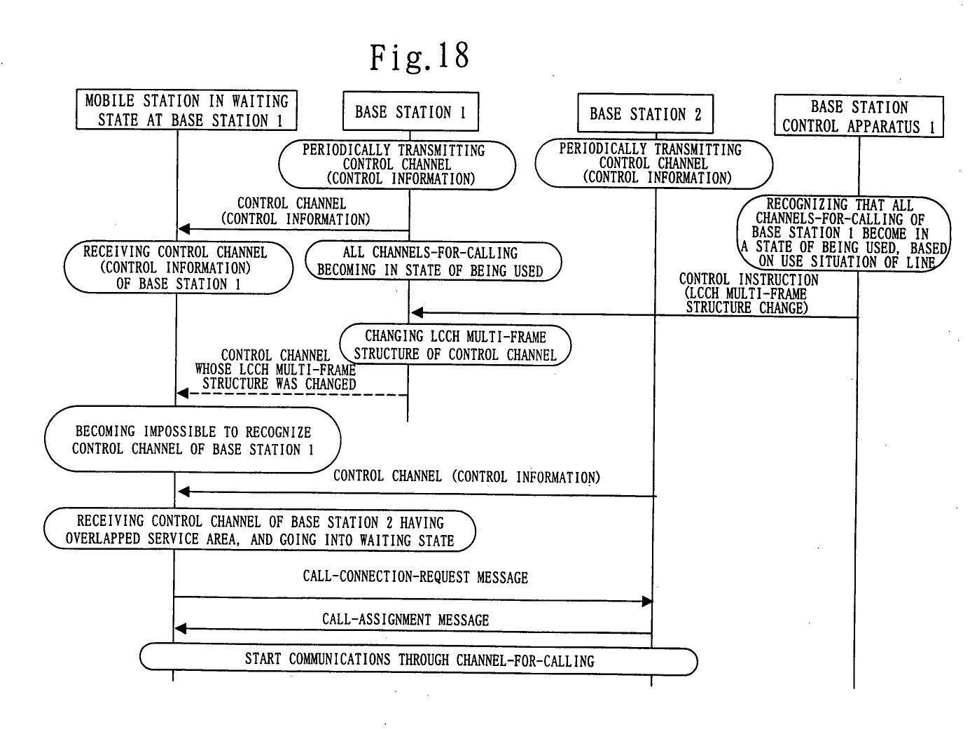

FIG. 18 shows a sequence of operations of the base station, the mobile station, and the base station control apparatus according to the present Embodiment. In FIG. 18, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 corresponds to the mobile station 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1, based on a usage situation of the line. Then, the base station control apparatus 1 transmits a control instruction which instructs the base station 1 to change the LCCH multi-frame structure of the control channel (control information).

Receiving the control instruction from the base station control apparatus 1, the base station 1 changes the LCCH multi-frame structure of the control channel (control information) based on the control instruction and transmits the control channel whose LCCH multi-frame structure was changed.

As the LCCH multi-frame structure of the control channel from the base station 1 was changed, it becomes impossible for the mobile station which has been in a waiting state with receiving the control channel from the base station 1 to recognize the control channel from the base station 1. Then, the mobile station performs switching in order to receive the control channel of the base station 2 having an overlapped service area and a vacant channel-for-calling.

The structure of the base station according to the present Embodiment is the same as that shown in FIG. 23. In the present Embodiment, the communications part 305 for a control apparatus receives a control instruction from the base station control apparatus, the control information control part 304 instructs the control information generating part 302 to change the LCCH multi-frame structure, based on the control instruction, the control information generating part 302 generates control information with changing the LCCH multi-frame structure based on the instruction of the control information control part 304, and the communications part 301 for a mobile station transmits the control channel whose LCCH multi-frame structure was changed to the mobile station.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station transmits the control channel whose LCCH multi-frame structure was changed. Thus, it becomes impossible for the mobile station which has been in a waiting state in the base station to recognize the control channel from the base station. Then, the mobile station connects to other neighboring base station.

### Embodiment 17

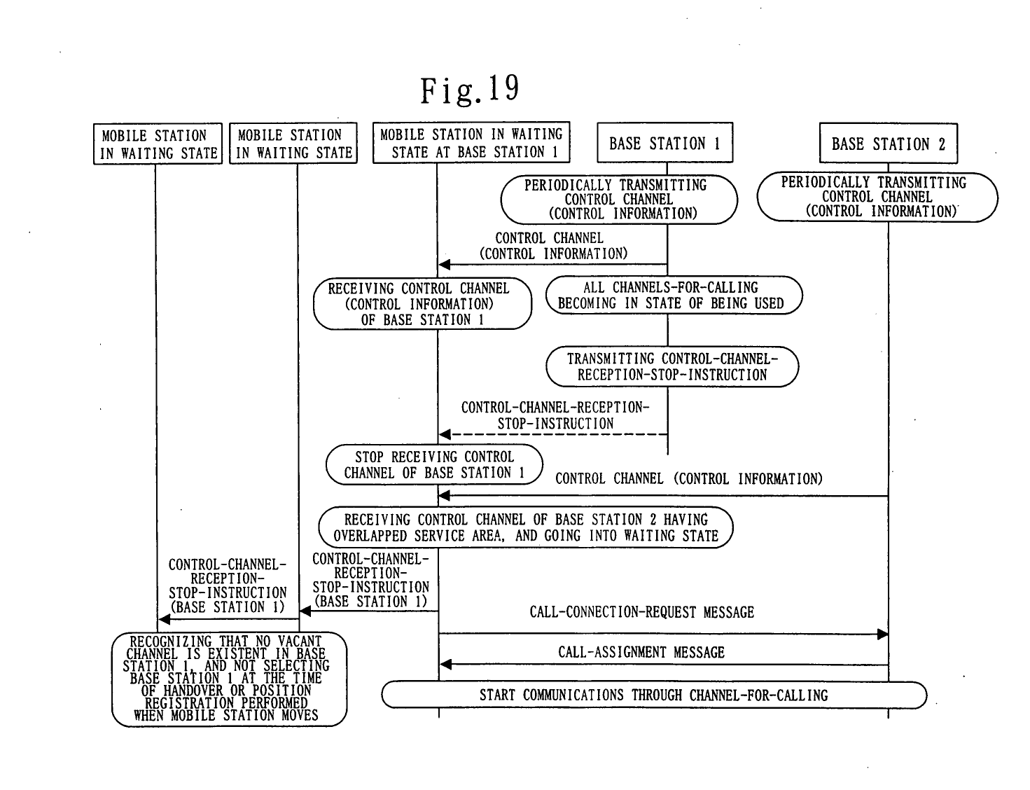

FIG. 19 shows a sequence of operations of the base station, and the mobile station according to the present Embodiment. In FIG. 19, the base station 1 corresponds to the base station 3a of FIG. 1, the base station 2 corresponds to the base station 3b of FIG. 1, and the mobile station in a waiting state at the base station 1 and other mobile stations in a waiting state correspond to the mobile stations 2b of FIG. 1.

When all the channels-for-calling become in a state of being used (or when traffic exceeds a specific level) in the base station 1, the base station 1 generates a control-channel-reception-stop-instruction (reception-stop-instruction information) which instructs the mobile station to stop receiving the control channel (control information), and transmits the generated control-channel-reception-stop-instruction to a specific mobile station in a waiting state.

Receiving the control-channel-reception-stop-instruction from the base station 1, the mobile station stops receiving the control channel from the base station 1. Then, the mobile station performs switching in order to receive the control channel of the base station 2 and transmits the control-channel-reception-stop-instruction to other neighboring mobile station.

Receiving the control-channel-reception-stop-instruction, the neighboring mobile station stops receiving the control channel from the base station 1. Then, the neighboring mobile station performs switching in order to receive the control channel of the base station 2 and transmits the control-channel-reception-stop-instruction to another neighboring mobile station.

Henceforth, by repeating the transmission of the control-channel-reception-stop-instruction between the mobile stations, the control-channel-reception-stop-instruction is forwarded from one of a plurality of mobile stations in a waiting state at the base station 1 to another of the plurality of mobile stations in a waiting state at the base station 1 one by one.

Thereby, the mobile station connects to the base station 2 having a vacant channel, without selecting the base station 1, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, the base station transmits a control-channel-reception-stop-instruction to a mobile station in a waiting state, the mobile station which received the control-channel-reception-stop-instruction from the base station performs switching so that it may be in a waiting state at other base station and autonomously transmits the control-channel-reception-stop-instruction periodically to a neighboring mobile station. Furthermore, the neighboring mobile station which received the control-channel-reception-stop-instruction from the mobile station similarly transmits it to other neighboring mobile station.

### Embodiment 18

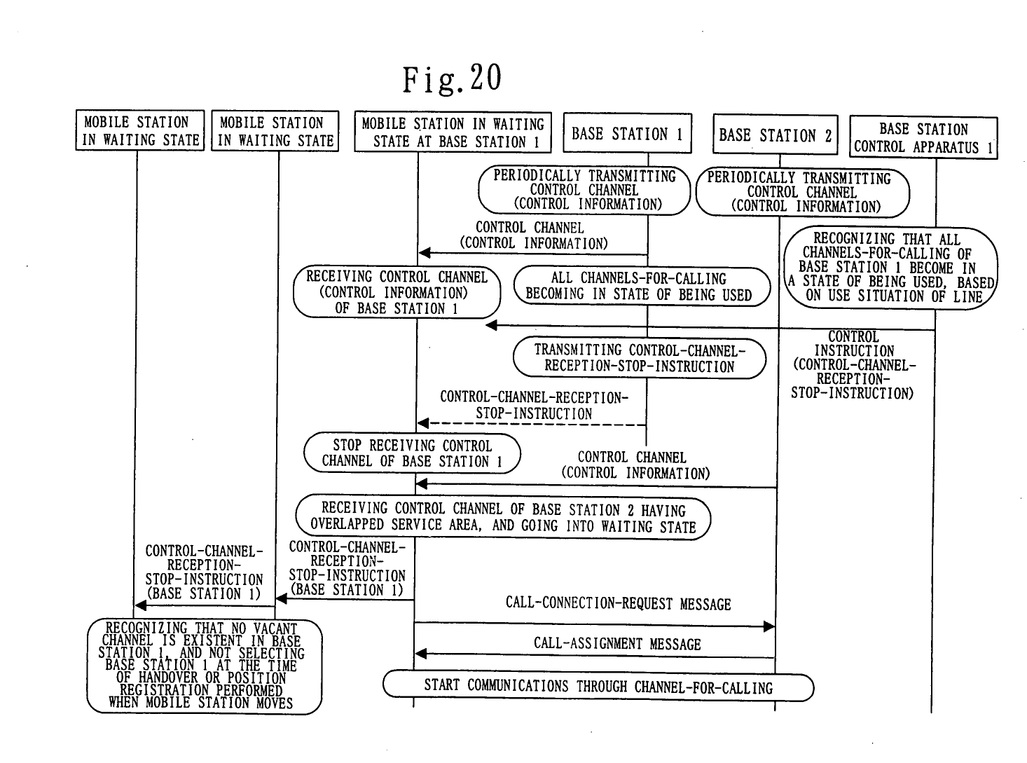

FIG. 20 shows a sequence of operations of the base station, the mobile station, and the base station control apparatus according to the present Embodiment. In FIG. 20, the base station 1 corresponds to the base station 3a of FIG. 1, the base station 2 corresponds to the base station 3b of FIG. 1, the base station control apparatus 1 corresponds to the base station control apparatus 4a of FIG. 1, and the mobile station in a waiting state at the base station 1 and other mobile stations in a waiting state correspond to the mobile stations 2b of FIG. 1.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1, based on a usage situation of the line. Then, the base station control apparatus 1 transmits a control instruction which instructs the base station 1 to transmit a control-channel-reception-stop-instruction.

Receiving the control instruction from the base station control apparatus 1, the base station 1 generates a control-channel-reception-stop-instruction based on the control instruction and transmits the generated control-channel-reception-stop-instruction to a specific mobile station in a waiting state.

Receiving the control-channel-reception-stop-instruction from the base station 1, the mobile station stops receiving the control channel from the base station 1. Then, the mobile station performs switching in order to receive the control channel of the base station 2 and transmits the control-channel-reception-stop-instruction to other neighboring mobile station.

Receiving the control-channel-reception-stop-instruction, the neighboring mobile station stops receiving the control channel from the base station 1, perform switching in order to receive the control channel of the base station 2 and transmit the control-channel-reception-stop-instruction to another neighboring mobile station.

Henceforth, by repeating the above procedure, the control-channel-reception-stop-instruction is forwarded from one of a plurality of mobile stations in a waiting state at the base station 1 to another of the plurality of mobile stations in a waiting state at the base station 1 one by one.

Thereby, the mobile station connects to the base station 2 having a vacant channel, without selecting the base station 1, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, based on an instruction from the base station control apparatus which controls the base station, the base station transmits a control-channel-reception-stop-instruction to a mobile station in a waiting state, the mobile station which received control-channel-reception-stop-instruction from the base station performs switching so that it may be in a waiting state at other base station and autonomously transmits the control-channel-reception-stop-instruction periodically to a neighboring mobile station. Furthermore, the neighboring mobile station which received the control-channel-reception-stop-instruction from the mobile station similarly transmits it to other neighboring mobile station.

### Embodiment 19

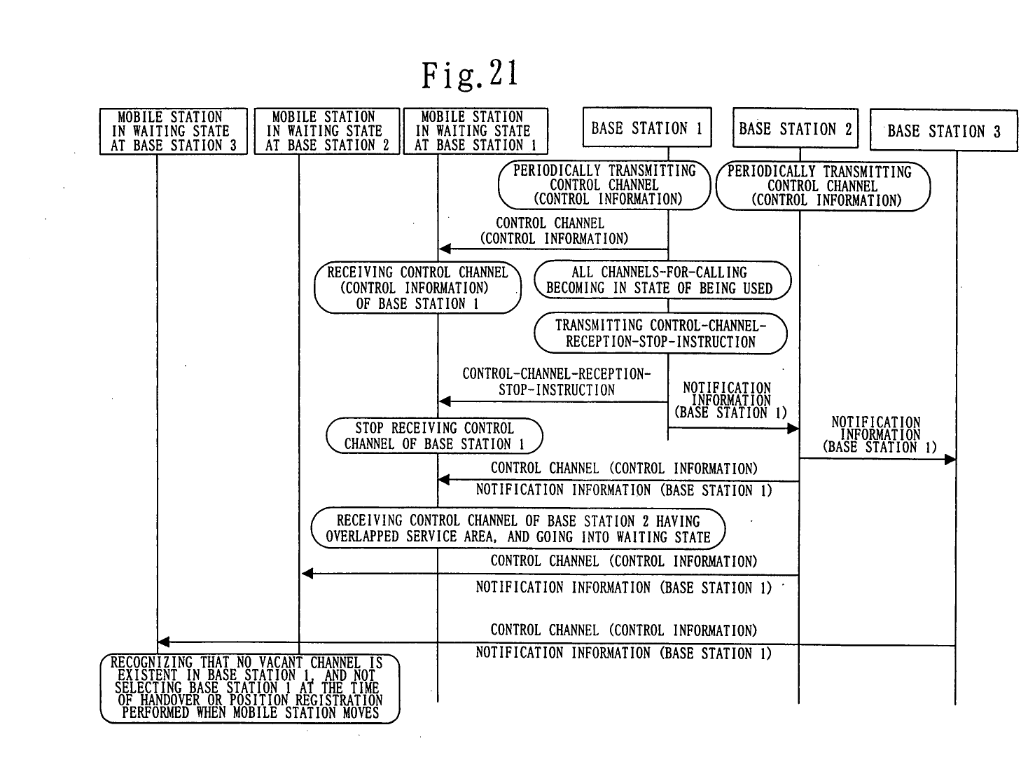

FIG. 21 shows a sequence of operations of the base station, and the mobile station according to the present Embodiment. In FIG. 21, the base station 1 corresponds to the base station 3a of FIG. 1, the base station 2 corresponds to the base station 3b of FIG. 1, the base station 3 corresponds to the base station 3c or 3d of FIG. 1, the mobile station in a waiting state at the base station 1 corresponds to one of the mobile stations 2b of FIG. 1, which receives the control channel from the base station 3a, the mobile station in a waiting state at the base station 2 corresponds to one of the mobile stations 2b of FIG. 1, which receives the control channel from the base station 3b, and the mobile station in a waiting state at the base station 3 corresponds to one of the mobile stations 2b of FIG. 1, which receives the control channel from the base station 3c or 3d.

When all the channels-for-calling become in a state of being used (or when traffic exceeds a specific level) in the base station 1, the base station 1 transmits a control-channel-reception-stop-instruction (reception-stop-instruction information) which instructs the mobile station to stop receiving the control channel (control information), and transmits notification information which notifies that receiving a call-connection-request message (a setting request for a communication channel) has been stopped, to the base station 2 located in the vicinity of the base station 1, through a wireless line.

The base station 2 which received the notification information from the base station 1 transmits the notification information to the mobile station in a waiting state in order to notify that the base station 1 has stopped receiving a call-connection-request message (a setting request for a communication channel), and transmits the notification information to the base station 3 located in the vicinity of the base station 2 in order to notify that the base station 1 has stopped receiving a call-connection-request message (a setting request for a communication channel), through a wireless line.

The base station 3 which received the notification information from the base station 2 transmits the notification information to the mobile station in a waiting state in order to notify that the base station 1 has stopped receiving a call-connection-request message (a setting request for a communication channel), and transmits the notification information to other base station located in the vicinity in order to notify that the base station 1 has stopped receiving a call-connection-request message (a setting request for a communication channel), through a wireless line.

Henceforth, by repeating the transmission of the notification information between the base stations, the notification information is forwarded from one of a plurality of base stations to another of the plurality of base stations one by one.

Thereby, the mobile station connects to a base station which can receive a call-connection-request message, without selecting the base station 1 which has stopped receiving the call-connection-request message, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, the base station transmits a control-channel-reception-stop-instruction to a mobile station in a waiting state, and notifies at least one neighboring base station that the base station has stopped receiving the call-connection-request message, through a wireless line. A neighboring base station which received the notification periodically transmits it to a mobile station in a waiting state in the own cell. Then, the neighboring base station which received the notification information from the base stations similarly transmits the notification information to other base station in the vicinity.

### Embodiment 20

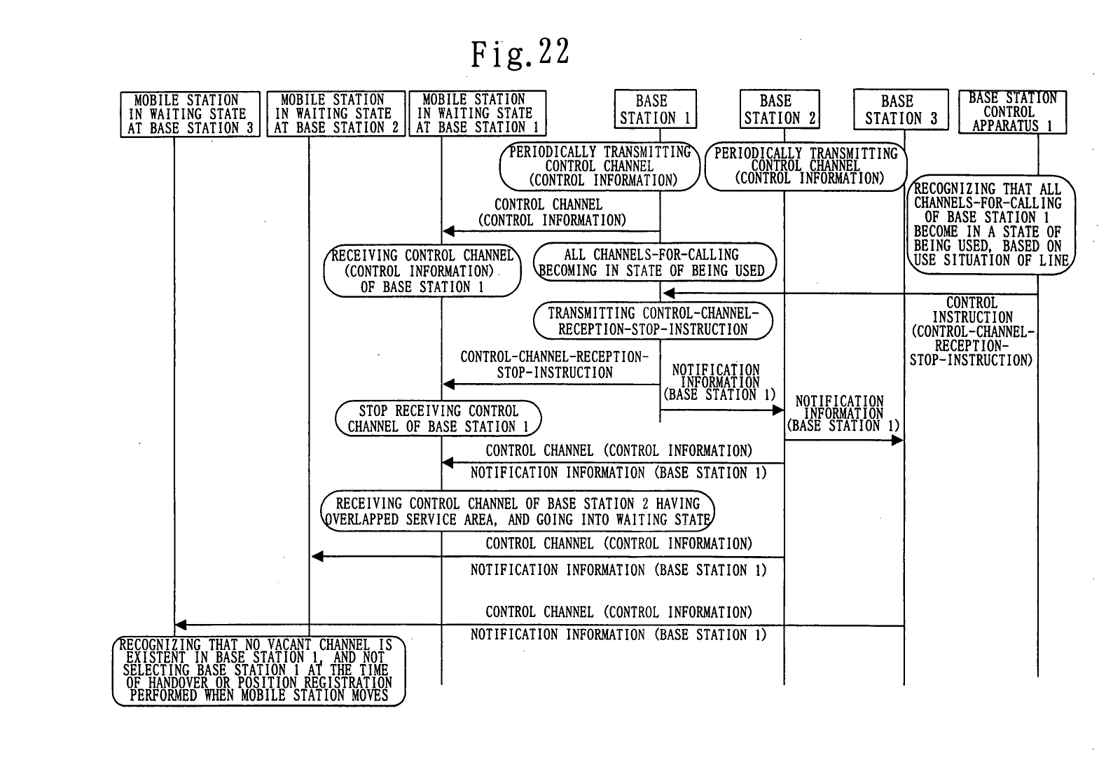

FIG. 22 shows a sequence of operations of the base station, the mobile station, and the base station control apparatus according to the present Embodiment. In FIG. 22, the base station 1 corresponds to the base station 3a of FIG. 1, the base station 2 corresponds to the base station 3b of FIG. 1, the base station 3 corresponds to the base station 3c or 3d of FIG. 1, the base station control apparatus 1 corresponds to the base station control apparatus 4a of FIG. 1, the mobile station in a waiting state at the base station 1 corresponds to one of the mobile stations 2b of FIG. 1, which receives the control channel from the base station 3a, the mobile station in a waiting state at the base station 2 corresponds to one of the mobile stations 2b of FIG. 1, which receives the control channel from the base station 3b, and the mobile station in a waiting state at the base station 3 corresponds to one of the mobile stations 2b of FIG. 1, which receives the control channel from the base station 3c or 3d.

When all the channels-for-calling become in a state of being used (or when traffic exceeds a specific level) in the base station 1, the base station control apparatus 1 recognizes that all the channels-for-calling become in a state of being used (or traffic exceeds a specific level) in the base station 1 based on a usage situation of the line. Then, the base station control apparatus 1 generates a control instruction which instructs the base station 1 to generate a control-channel-reception-stop-instruction (reception-stop-instruction information) directing mobile station in a waiting state at the base station 1 to stop receiving the control channel (control information) from the base station 1, and transmits the generated control instruction to the base station 1.

Then, the base station 1 generates the control-channel-reception-stop-instruction (reception-stop-instruction information) based on the control instruction, and transmits it to the mobile station in a waiting state at the base station 1.

In addition, the base station 1 generates notification information which notifies that the base station 1 has stopped receiving a call-connection-request message (a setting request for a communication channel) and transmits the notification information to the base station 2 located in the vicinity of the base station 1.

Receiving the notification information, the base station 2 notifies the mobile station in a waiting state that no vacant channel-for-calling becomes existent in the base station 1 and transmits the notification information to the mobile station in a waiting state in order to notify that the base station 1 has stopped receiving a call-connection-request message (a setting request for a communication channel). Then, the base station 2 transmits the notification information to the base station 3 located in the vicinity of the base station 2 in order to notify that the base station 1 has stopped receiving a call-connection-request message (a setting request for a communication channel), through a wireless line.

Receiving the notification information from the base station 2, the base station 3 notifies the mobile station in a waiting state that the base station 1 has stopped receiving a call-connection-request message (a setting request for a communication channel). Then, the base station 3 transmits the notification information to other base station located in the vicinity in order to notify that the base station 1 has stopped receiving a call-connection-request message (a setting request for a communication channel), through a wireless line.

Henceforth, by repeating the transmission of the notification information between the base stations, the notification information is forwarded from one of a plurality of mobile stations to another of the plurality of mobile stations one by one.

Thereby, the mobile station connects to a base station which receives a call-connection-request message, without selecting the base station 1 which has stopped receiving the call-connection-request message, at the time of handover or a location registration performed when the mobile station moves to other cell.

As mentioned above, the mobile communications system according to the present Embodiment has the following feature: when no vacant channel-for-calling becomes existent or traffic exceeds a specific level in one base station, based on the instruction of the base station control apparatus which controls the base station, the base station transmits a control-channel-reception-stop-instruction to the mobile station in a waiting state, and notifies at least one neighboring base station that the base station has stopped receiving a call-connection-request message, through a wireless line. Further, a neighboring base station which received the notification transmits it periodically to a mobile station in a waiting state in the own cell. Then, the neighboring base station received the notification information from the base stations similarly transmits the notification to other base station in the vicinity.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only, and not intended to be limiting. The invention is limited only as defined in the following claims and the equivalents thereto.

What is claimed is:

1. A base station which continuously transmits control information to at least one communication terminal in an area in order to perform a communication control of the communication terminal, comprising:
a control information generating part for generating control information;
a communications part for continuously transmitting the control information generated by the control information generating part to the communication terminal in the area; and
a control information control part, in a certain case, for making the communication terminal in the area unable to recognize the control information by controlling at least one of the control information generating part and the communications part.

2. The base station of claim 1, wherein the control information control part performs an analysis of the communication control of the communication terminal in the area, and when a specific analysis result is obtained, makes the communication terminal in the area unable to recognize the control information by controlling at least one of the control information generating part and the communications part.

3. The base station of claim 1, wherein the base station is connected to a base station control apparatus, the communications part can receive a control instruction which instructs the control information control part to control the control information, from the base station control apparatus, and the control information control part, in a case of the communications part receiving the control instruction from the base station control apparatus, makes the communication terminal in the area unable to recognize the control information, by controlling at least one of the control information generating part and the communications part.

4. The base station of claim 2, further comprising a communication channel setting part for managing at least one communication channel which can be set for the communication terminal in the area, receiving a setting request for a communication channel from the communication terminal in the area which received the control information, and setting the communication channel for the communication terminal in the area having sent the setting request for the communication channel,
wherein the control information control part analyzes a setting situation of the communication channel for the communication terminal in the area, and in a case of a number of vacant communication channels which are not set for the communication terminal in the area becoming equal to or less than a certain number, makes the communication terminal in the area unable to recognize the control information, by controlling at least one of the control information generating part and the communications part.

5. The base station of claim 2, further comprising a communication channel setting part for managing at least one communication channel which can be set for the communication terminal in the area, receiving a setting request for a communication channel from the communication terminal in the area which received the control information, and setting the communication channel for the communication terminal in the area having sent the setting request for the communication channel,
wherein the control information control part analyzes communication traffic of another communication terminal in the area for which the communication channel has been set, and in a case of the communication traffic of the another communication terminal in the area for which the communication channel has been set becoming equal to or greater than a specific level, makes the communication terminal in the area unable to recognize the control information, by controlling at least one of the control information generating part and the communications part.

6. The base station of claim 1, wherein the control information control part, in a certain case, gives an instruction to the communications part to stop transmitting the control information, and the communications part stops transmitting the control information to the communication terminal in the area, based on the instruction from the control information control part.

7. The base station of claim 1, wherein the control information control part, in a certain case, gives an instruction to the control information generating part to generate the control information by using a signal configuration which the communication terminal in the area can not recognize the control information, the control information generating part generates the control information by using the signal configuration which the communication terminal in the area can not recognize the control information, based on the instruction from the control information control part, and the communications part transmits the control information generated by the control information generating part using the signal configuration which the communication terminal in the area can not recognize the control information, to the communication terminal in the area.

8. The base station of claim 7, wherein the control information generating part generates the control information including a unique word, the control information control part, in a certain case, gives an instruction to the control information generating part to change at least a part of the unique word, and the control information generating part generates the control information by changing at least a part of the unique word, based on the instruction of the control information control part.

9. The base station of claim 7, wherein the control information generating part generates the control information having a certain frame length, the control information control part, in a certain case, gives an instruction to the control information generating part to change the frame length of the control information, and the control information generating part generates the control information by changing the frame length, based on the instruction of the control information control part.

10. The base station of claim 7, wherein the control information generating part generates the control information having a certain LCCH (Logical Control CHannel) multi frame structure, the control information control part, in a certain case, gives an instruction to the control information generating part to change the LCCH multi frame structure, and the control information generating part generates the control information by changing the LCCH multi frame structure, based on the instruction of the control information control part.

11. A base station which continuously transmits control information to at least one communication terminal in an area in order to perform a communication control of the communication terminal in the area, comprising:
a communications part for continuously transmitting the control information to the communication terminal in the area; and
a control information control part, in a certain case, for generating reception-stop-instruction information which instructs the communication terminal in the area to stop receiving the control information,
wherein the communications part transmits the reception-stop-instruction information generated by the control information control part to the communication terminal in the area.

12. The base station of claim 11, wherein the control information control part performs an analysis of the communication control of the communication terminal in the area, and in a case of obtaining a specific analysis result, generates the reception-stop-instruction information.

13. The base station of claim 11, wherein the base station is connected to a base station control apparatus, the communications part can receive a control instruction which instructs the control information control part to generate reception-stop-instruction information, from the base station control apparatus, and the control information control part, in a case of the communications part receiving the control instruction from the base station control apparatus, generates the reception-stop-instruction information.

14. The base station of claim 12, further comprising a communication channel setting part for managing at least one communication channel which can be set for the communication terminal in the area, receiving a setting request for a communication channel from the communication terminal in the area which received the control information, and setting the communication channel for the communication terminal in the area having sent the setting request for the communication channel,
wherein the control information control part analyzes a setting situation of the communication channel for the communication terminal in the area, and generates the reception-stop-instruction information in a case of a number of vacant communication channels which are not set for the communication terminal in the area becoming equal to or less than a certain number.

15. The base station of claim 12, further comprising a communication channel setting part for managing at least one communication channel which can be set for the communication terminal in the area, receiving a setting request for the communication channel from the communication terminal in the area which received the control information, and setting a communication channel for the communication terminal in the area having sent the setting request for the communication channel,
wherein the control information control part analyzes communication traffic of another communication terminal in the area for which the communication channel has been set, and in a case of the communication traffic of the another communication terminal in the area for which the communication channel has been set becoming equal to or greater than a specific level, generates the reception-stop-instruction information.

16. The base station of claim 11, wherein the base station transmits the control information to a plurality of communication terminals in the areas, and the communications part, in a case of the control information control part generating the reception-stop-instruction information, transmits the reception-stop-instruction information to a specific communication terminal in the area, and makes the reception-stop-instruction information transmitted from the specific communication terminal in the area to another communication terminal in the area one by one.

17. A communication system comprising:
a first base station for managing a communication-terminal-in-first-area which exists in a first area, holding a communication channel which can be set for the communication-terminal-in-first-area, and setting the communication channel for the communication-terminal-in-first-area by receiving a setting request for the communication channel from the communication-terminal-in-first-area; and
a second base station for managing a communication-terminal-in-second-area which exists in a second area,
wherein the first base station, in a certain case, stops receiving the setting request for the communication channel from the communication-terminal-in-first-area, generates notification information which notifies that receiving the setting request for the communication channel has been stopped, and transmits the notification information generated by the first base station to the second base station, and the second base station receives the notification information transmitted from the first base station and transmits the notification information received to the communication-terminal-in-second-area.

18. The communication system of claim 17, wherein the first base station is connected to the second base station through a base station control apparatus, and in a case of generating the notification information, transmits the notification information to the second base station through the base station control apparatus.

19. The communication system of claim 17, wherein the first base station is connected to a first base station control apparatus and the second base station is connected to a second base station control apparatus which is connected to the first base station control apparatus, and the first base station, in a case of generating the notification information, transmits the notification information to the second base station through the first base station control apparatus and the second base station control apparatus.

20. The communication system of claim 17, wherein the second base station can communicate with a base station other than the first base station, and in a case of receiving the notification information transmitted from the first base station, transmits the notification information received to the base stations other than the first base station.

21. Abase station control apparatus which is connected to a plurality of base stations and controls the plurality of base stations, wherein each of the plurality of base stations has a management area as a management object, holds a communication channel which can be set for a communication terminal in its management area, and when receiving a setting request for the communication channel from the communication terminal in its management area, sets the communication channel for the communication terminal in its management area,
wherein the base station control apparatus, in a case of a specific base station having stopped receiving the setting request for the communication channel, detects that the specific base station has stopped receiving the setting request for the communication channel, generates notification information which notifies that the specific base station has stopped receiving the setting request for the communication channel, transmits generated notification information to a base station other than the specific base station, and makes the base station other than the specific base station transmit the generated notification information to the communication terminal in its management area.

22. The base station control apparatus of claim 21, wherein the base station control apparatus is connected to another base station control apparatuses which controls at least one base station, and in the case of generating the notification information, transmits a generated notification information to the another base station control apparatuses, and makes the another base station control apparatuses transmit the generated notification information to a base station which the another base station control apparatuses controls.

23. The base station control apparatus of claim 21, wherein the base station control apparatus is connected to another base station control apparatus which controls at least one base station which sets the communication channel for a communication terminal when receiving a setting request for the communication channel from the communication terminal, and
wherein the base station control apparatus, when one base station which is controlled by the another base station control apparatus stops receiving the setting request for the communication channel, receives notification information from the another base station control apparatus which notifies that the one base station which is controlled by the another base station control apparatus has stopped receiving the setting request for the communication channel, transmits a received notification information to the plurality of base stations, and makes the plurality of base stations transmit the received notification information to the communication terminal in the management area of each base station.
